(19) United States
(12) Patent Application Publication
(10) Pub. No.: US 2002/0130953 A1
(43) Pub. Date: Sep. 19, 2002

(54) Enhanced display of environmental navigation features to vehicle operator

(76) Inventors: John Riconda, Valley Stream, NY (US); David Michael Geshwind, New York, NY (US)

Correspondence Address: Anne C. Avellone, Esq., 60 West 66th Street - 36J, New York, NY, 10023, US

(21) Appl. No.: 10/097,029

(22) Filed: Mar. 12, 2002

Related U.S. Application Data
(60) Provisional application No. 60/275,398, filed on Mar. 13, 2001.

(51) Int. Cl. H04N 7/18

(52) U.S. Cl. 348/115; 348/148; 382/104; 382/254

(57) ABSTRACT

Imaging device is trained (e.g., panned, zoomed, focussed) on environmental navigation feature, such as street sign or house number, by operator input and computer control. Optional illumination in visible, infrared, ultraviolet, or other spectrum enhances (especially nighttime) imaging. Optional processing is applied to image to increase brightness, sharpness and/or size, and/or to counter positional or other distortion or error. Computer controlled motion tracking, affected by pattern recognition algorithms with optional artificial intelligence, and/or freeze frame function, and/or optical or digital image stabilization, are used to stabilize view from moving vehicle.

### CROSS-REFERENCE TO RELATED APPLICATIONS

Pursuant to 35 USC §119 claims priority based upon U.S. Provisional Patent Application No. 60/275,398, filed Mar. 13, 2001.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright and other intellectual property rights whatsoever. Nevertheless, it is acknowledged that the content of FIGS. 1A, 1B, 1C and 1D were derived from web postings of the Cadillac division of General Motors; and, those images are, presumably, copyright to those companies and under their control.

### BACKGROUND OF THE INVENTION

1. Field of the Invention

The instant invention relates to the, generally, enhanced display of an environmental navigation feature, such as a street sign or house number, to the operator or passenger of a motor vehicle. Optional illumination in a visible or extravisible range assists the capture of an image by a digital camera or similar imaging device. The imaging device is trained upon and, optionally, tracks the feature, under control of operator input and automated motion tracking by image processing and artificial intelligence. Pattern recognition, image processing and artificial intelligence are, optionally, used for image enhancement and/or reconstruction. Optical or digital image stabilization and/or freeze frame create stable images from moving vehicles.

2. Description of Related Art

Those who practice the instant invention are those familiar with, and skilled in, arts such as: electrical, electronic, systems, computer, digital, communications, mechanical, automotive, optical, television, imaging, image recognition and processing, control systems, intelligent systems, and other related hardware and software engineering and design disciplines. Nevertheless, the inventive matter does not constitute these arts in and of themselves, and the details of these arts are within the public domain and the ken of those skilled in the arts.

The instant disclosure will not dwell on the details of system implementation in such arts but will, instead, focus on the novel designs of: systems, components, data structures, interfaces, processes, functions and program flows, and the novel purposes for which these are utilized.

The instant application relies on the existence of well-known techniques, systems and components including, but not limited to: digital computers and embedded control systems; CCD and other digital imaging components; digital video processing systems¹; compact video cameras, with features including automatic focussing, optical and digital zoom, optical and digital image stabilization, signal amplification, infrared imaging, etc.²; remote and automatic focussing, zooming and positioning of cameras, and the affiliated mountings and electromechanical controls; automatic and remote controlled movable mountings³ for video and still cameras, telescopes, automobile mirrors, spot and flood lights, etc.; spot and flood illumination in the range of, and imaging components sensitive to, visible light, infrared (both near visible and heat imaging), ultraviolet and other extravisible spectra; photomultiplication and other image brightening, ‘night vision’ or fog-cutting imaging technologies⁴; fiber optic and other light guide materials⁵; digital pattern recognition and image processing; artificial intelligence; electronic navigation aids, such as global positioning satellite (“GPS”) technology⁶; extant automobile imaging systems, such as the Cadillac Night Vision System; and, other related devices and technologies, and those which may be substituted for them. In fact, consumer, commercial and military components now available can be integrated, with little to no modification, to provide all the necessary elements, except some additional software control functions, to perform many of the embodiments, as described herein; and, the necessary modifications and/or additions are within those skilled in the appropriate arts.

The intended scope of the instant invention also includes the combination with other related technologies, now in existence or later developed, which may be combined with, or substituted for, elements of the instant invention.

In particular, it is noted that the Cadillac Night Vision System has some similarities to the instant invention. However, there are, more importantly, major differences:

the purpose of the Cadillac Night Vision System is to visualize objects in the road that might constitute danger (e.g., deer, pedestrians, other vehicles, etc. as shown in the Cadillac demonstration images, FIGS. 1A, 1B, 1C and 1D) but which may not otherwise be seen; in contrast the purpose of the instant invention is to better visualize navigation aids such as street, road, highway and store signs, house numbers, etc.

the Cadillac Night Vision System employs heat range infrared, is specifically intended for use at night, and in fact, as seen in the Cadillac demonstration images (FIGS. 1A, 1B, 1D and 1C), road signs are specifically made unreadable by this system; in contrast the instant system is intended to be used night and day and employs visible, ultraviolet and near-visible infrared (to whatever extent near IR is useful) illumination to read street road signs.

the Cadillac Night Vision System employs an essentially static forward-looking camera view with a ‘heads-up’ display overlaid on the windshield road view; in contrast, the instant invention ideally employs a CRT or LCD dash-mounted display which shows items not directly in the driver's field of view and, thus, has a wide-ranging, highly adjustable, remote controlled and, optionally, automatically tracking, perspective, and which will, generally, enlarge distant objects rather than coordinate them with the ‘live’ view of the road.

Of other prior art, several, which are the most closely related to the instant invention, bear discussion.

U.S. Pat. No. 5,729,016 describes a heat vision system that provides to law enforcement and marine vehicles the ability to, for example, follow a perpetrator in the dark or locate a person who has fallen overboard into the water. Thus, as with the Cadillac system described elsewhere, such a system is unsuitable for the present invention since objects like street signs are not displayed, except in outline. Nevertheless, this patent demonstrates that it is well known in the art how to install camera and display systems in vehicles.

Companion U.S. Pat. No. 5,598,207 describes a low-profile camera mount for use atop a police car, which mount moves in response to signals from a control system. The mount is described as suitable for an infrared camera useful to detect perpetrators in the dark. Again, such infrared technology is distinct from the instant invention. Nevertheless, this patent demonstrates that it is well known in the art how to install remote controlled camera mounts on vehicles. The instant invention, however, also provides zoom controls and image processing in addition to the pan and tilt controls disclosed in this patent.

U.S. Pat. No. 5,899,956 compensates for inaccuracies in a GPS system by using a camera system mounted in the vehicle to collect information about the vehicle's surroundings. Conversely, in the present invention, when camera and GPS systems are combined, the GPS system is used to improve the performance of the camera system. Further, the cited patent does not display any information that is collected by its camera (but, rather, provides audio instructions directing the driver) while the instant invention is primarily directed to just such functions. Nevertheless, this patent demonstrates that it is well known in the art how to interface and exchange information between camera and GPS (or similar) systems in vehicles.

Similarly, U.S. Pat. No. 5,844,505 uses a starting location entered by the driver and inertial guidance technology to approximate location. Again, a camera view of the surroundings compensates for the inaccuracies of that system. Again, this is the converse of the instant invention. Further, again, the camera output is not presented to the driver in the cited patent, but synthesized voice directions are. Presenting camera output to the driver is key to the instant invention. Nevertheless, this patent demonstrates that it is well known in the art how to extract navigational information from road signs and the like.

U.S. Pat. No. 5,963,148 is quite similar to the Cadillac system in that it uses an infrared imaging system (with GPS assist) to display the shape, condition of the road or hazards ahead (e.g. curve, ice, snow, pedestrian) to the driver. A standard camera is also used, but just to display, as an underlayer, the overall shape of the road ahead, and is not trained on road signs; and, their display is not the subject of this patent. Further, this patent does not provide camera positioning means. Nevertheless, this patent demonstrates that it is well known in the art how to integrate GPS systems with camera systems mounted in vehicles.

Lastly, in U.S. Pat. No. 6,233,523 B1, a moving vehicle is equipped with a system which combines GPS information about location with camera derived information about addresses. This is used to generate a database of buildings and locations within a given area. No camera information is displayed to the vehicle operator during vehicle operation and “The house number must always be determined optically, for example by direct view by a passenger in the vehicle, entering them immediately either manually or verbally into a computer, or by post view of any pictures taken.” (column 3, lines 26-30) Nevertheless, this patent shows that it is well known in the art how to create the sort of databases needed in the instant invention, for example, in (1523), (1730), etc.

### BRIEF SUMMARY OF THE INVENTION

The instant invention relates to a process and system for displaying, and optionally enhancing, an image of an environmental navigation feature, such as street sign or house number, to the operator or passenger of a motor vehicle. An additional display is also, optionally, provided that is convenient to the front passenger, or in the rear passenger compartment.

The imaging subsystem is, for example, a CCD or similar digital imaging device embodied as a video or still camera. The camera is, optionally, equipped with remote focussing and zooming controls; and is, optionally, affixed to a mount with remote horizontal and vertical positioning transducers. The optical and pointing controls are input from a combination of an operator input device (e.g., a multiple axis joystick) and/or a computer algorithm employing pattern recognition of features (e.g., text, edges, rectangles, areas of color) and optional artificial intelligence.

The imaging system is trained on, and optionally tracks, the item of interest, by panning, zooming and/or focussing. Optional illumination in the visible, infrared, ultraviolet or other spectrum; and/or, photomultiplication or signal amplification (gain); and/or, telephoto optics; and/or, other image enhancement algorithms are employed. These are used especially at night, or at other times (e.g., sunset, sunrise, etc.), or in other situations (e.g., fog or precipitation, areas of shadow or glare, excessive distance, etc.), where human vision is not sufficient. Pattern recognition, with optional artificial intelligence, algorithms affect computer controlled motion tracking. Digital stabilization and/or freeze frame imaging are employed to stabilize the image during vehicle motion. Further image processing is, optionally, applied to the image to increase brightness, sharpness or size; and/or, to counter positional or other distortion or error; and/or, to apply other image enhancements or recognition features (e.g., text reconstruction coordinated with atlas look up); and/or to otherwise enhance or emphasize some part or feature of the image.

The imaging device is mounted on the dash, on the front or rear hood or grille, in the mirror cowlings, or otherwise. Further, a dash-mounted camera is, optionally, connected via a long cable, or radio or infrared interface, in order to permit its use: to view inaccessible or dark areas of the passenger cabin (e.g., look under the seat for dropped keys) in the glove box, etc.; or, to be affixed to a rear facing mount as a child monitor, or as an electronic rear view adjunct.

### BRIEF DESCRIPTION OF THE SEVERAL VIEWS OF THE DRAWING

FIG. 1A is a demonstration image of the Cadillac Night Vision System showing a night time scene with no illumination.

FIG. 1B is a demonstration image of the Cadillac Night Vision System showing a night time scene with low beams.

FIG. 1C is a demonstration image of the Cadillac Night Vision System showing a night time scene with high beams.

FIG. 1D is a demonstration image of the Cadillac Night Vision System showing a night time scene with the heat vision technology in use.

FIG. 2A depicts a camera in a two axis adjustable mounting (side view).

FIG. 2B depicts a camera in a two axis adjustable mounting (front view).

FIG. 3A depicts a four axis joy stick (front view).

FIG. 3B depicts a four axis joystick (side view).

FIG. 4 depicts a rear facing camera mount.

FIG. 5 depicts a camera with a long retractable cable.

FIG. 6 depicts alternative controls and displays mounted on a dashboard.

FIG. 7A depicts a camera mounted in a side mirror cowling (outer view).

FIG. 7B depicts a camera mounted in a side mirror cowling (inner detail).

FIG. 8 depicts a camera and lamp in a coordinated mounting.

FIG. 9A depicts a camera with annular lamp.

FIG. 9B depicts a camera with several surrounding lamps.

FIG. 10A depicts a schematic of a compound annular lens (side view).

FIG. 10B depicts a schematic of a compound annular lens (front view).

FIG. 10C depicts a schematic of a convex element of a compound annular lens.

FIG. 10D depicts a schematic of a concave element of a compound annular lens.

FIG. 11A depicts an annular light guide (cutaway view).

FIG. 11B depicts an annular light guide (one alternative segment).

FIG. 12A depicts a perspective-distorted rectangular street sign.

FIG. 12B depicts the counter-distortion of a rectangular street sign.

FIG. 12C illustrates the destination rectangle of the counter-distortion algorithm.

FIG. 12D illustrates the source quadrilateral of the counter-distortion algorithm.

FIG. 12E illustrates the bilinear interpolation used in the counter-distortion algorithm.

FIGS. 12F and 12G comprise program code to perform the counter-distortion algorithm.

FIG. 13 depicts the partial recognition of text.

FIG. 14 depicts a system diagram of each camera subsystem.

FIG. 15 depicts an overall system diagram.

FIG. 16 depicts program flow for partial text look-up.

FIG. 17 depicts program flow for feature recognition.

FIG. 18A depicts program flow for image tracking.

FIG. 18B depicts an alternate program flow for image tracking.

FIG. 19 depicts alternate placement of cameras.

### DETAILED DESCRIPTION OF THE INVENTION WITH REFERENCE TO THE DRAWINGS

Motivation:

When driving, particularly in areas that one is unfamiliar with, undue attention need be paid to deciphering street signs, highway and road signs, house numbers, store signs, etc., when that attention should be paid to driving instead.

This situation is exacerbated: at night, or other times (e.g., dawn or dusk) by areas of shadow and glare, when human vision is compromised; when weather conditions are adverse; signs are at large distances or partially obscured; when the vehicle is moving quickly or unevenly; when the driver is alone or when driving conditions require close attention; etc.

The instant invention addresses the need for a system that will:

display images of street signs, etc. large and clearly enough to be easily readable.

enhance the display of street signs, etc. to be bright enough to be easily readable at night or in adverse conditions.

enhance the display of street signs, etc. in other ways including, sharpening, increasing contrast, geometric distortion, etc.

provide its own illumination or image enhancing mechanism for low-light conditions.

be capable of training on a particular sign or other object.

be capable of tracking a particular sign or other object while the vehicle is moving.

be capable of recognizing and extracting text from signs, etc.

coordinating that text with a database, optionally coordinated with GPS or other locating or navigation devices, in order to identify partially obscured or otherwise unrecognizable text.

be usable for other purposes including, without limitation: to be positioned sideward or rearward; to search in dark or inconvenient recesses such as under seats, or in the glove compartment or trunk; to be a child minder; or, as an electronic rear view adjunct; for accident documentation; etc.

### A DESCRIPTION OF PREFERRED EMBODIMENTS

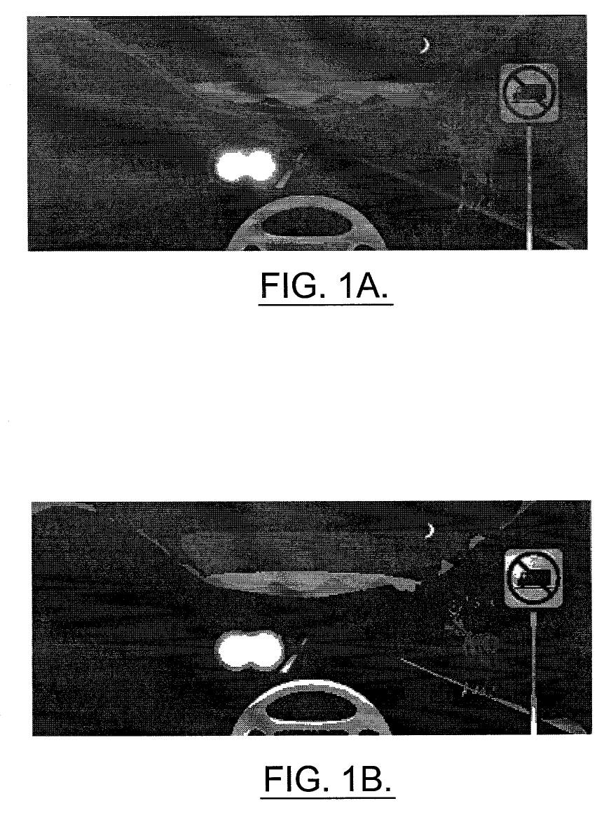

FIGS. 1A, 1B, 1C and 1D are demonstration images created by Cadillac to illustrate their “Night Vision” system. FIG. 1A shows a nighttime scene without illumination; FIG. 1B shows the same scene with illumination from low beam headlights; FIG. 1C shows the same scene with illumination from high beam headlights; and, FIG. 1D shows the same scene with illumination from Cadillac's “Night Vision” system. The primary element to note is that the ‘no trucks’ sign which is intelligible, to one degree or another, in FIGS. 1A, 1B and 1C, becomes completely unreadable in FIG. 1D. This is apparently because Cadillac's “Night Vision uses thermal-imaging, or infrared, technology to create pictures based on heat energy emitted by objects in the viewed scene.”⁷ While the pigments used in street and traffic and street signs are differentiable under visible light, they will, generally, be of a uniform temperature at night and, thus, appear blank to thermal imaging systems. Thus, the instant invention will not rely solely on thermal imaging, but will employ, variously, imaging devices sensitive to, and/or adjunct illumination in, the thermal infra-red, near-visible infrared, visible, ultraviolet or other energy spectra.

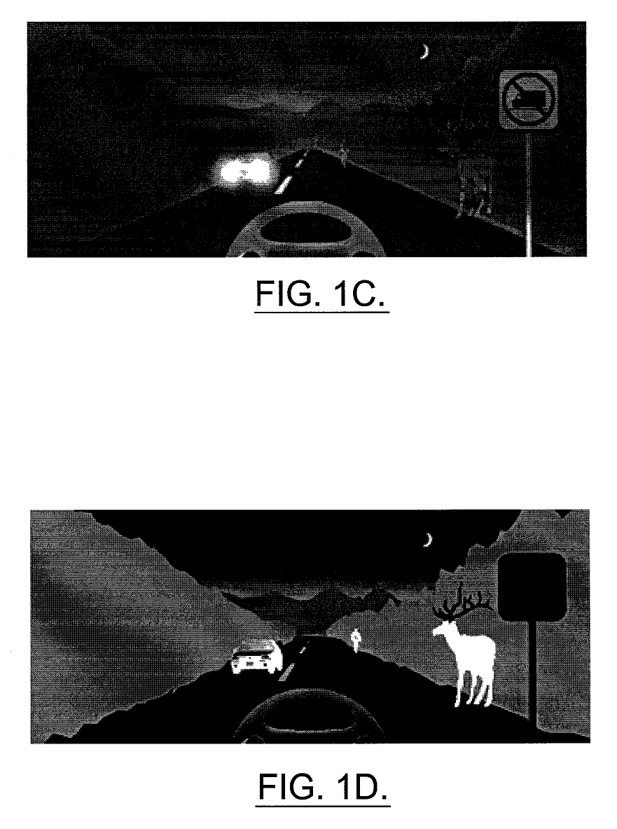

FIG. 2A depicts a camera in a two axis adjustable mounting from the side (200); and, FIG. 2B from the front (250). Certain elements such as adjustable focus, zoom and iris mechanisms, which are standard features, even in consumer cameras⁸, are not shown. Also, the entire camera subsystem shown here may be mounted to a base (210) or to the dashboard or other vehicle surface and, for that purpose, shaft (207) is optionally extended beyond rotational transducer (209). This structure is exemplary, and other mountings and configurations are commonly available and used by those skilled in the art for such purposes, and are within the scope of the instant invention⁹. The camera mechanism is mounted within a barrel (201) with a lens mechanism at one end (202). In this embodiment, the camera barrel is held within a flexible ‘C’ clip (203), such as is often used to hold microphones to their stands, with optional distentions (204) to assist holding barrel (201) in place once it is pushed into the clip. Pivoting shafts (205) permit the clip (203) with camera (201) to be remotely rotated up and down (pitched, tilted) by rotational transducer (208). That entire mechanism is held in bracket (206) which is attached to shaft (207) which is rotated left and right (yawed, panned) by rotational transducer (209).

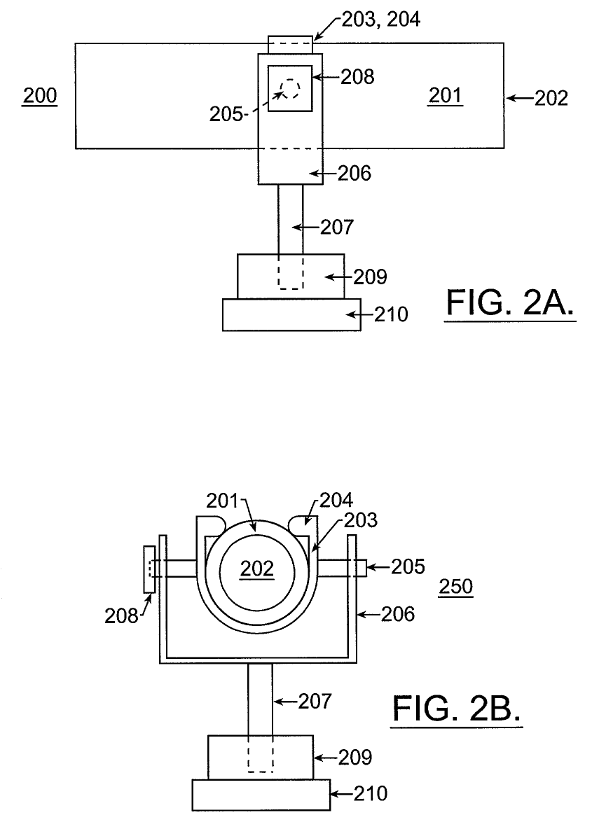

FIG. 3A depicts a four axis joystick from the front (300); and, FIG. 3B from the side (350). The knob (302) attached to shaft (303) and protruding from face plate (301) is moved left and right (304) to control camera yaw or pan, and up and down (305) to control camera pitch or tilt. Such two-axis (as described thus far) devices are commonly used in automobiles to control side-view mirrors. A second joystick is, optionally, used for a second set of two axes, or the same two axes may be used with a toggle (not shown) selecting between sets. However, in this embodiment, the other two axes are controlled by rotating the knob/shaft (302/303) clockwise or counterclockwise (306) or moving it in and out (push/pull) (307). These additional axes are used to control camera zoom and, if necessary, manual (but remote) focus, to replace, override or augment the preferred autofocussing embodiment. The internal electromechanical transducers in such devices are well known in the art and have been omitted for clarity. This configuration is exemplary and other mechanisms and configurations are used in the art and within the scope of the instant invention.

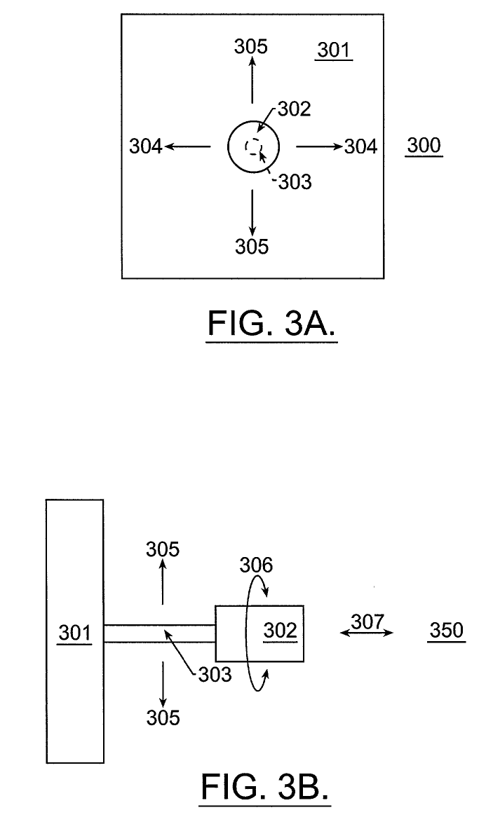

FIG. 4 depicts a rear facing camera mount. Similarly to FIG. 2, a flexible ‘C’ clip (403), such as is often used to hold microphones to their stands, with optional distentions (404) to assist holding the camera barrel (e.g., 201) is attached to a shaft (402) anchored to the ‘hump’ (405) between two bucket seats (401), or otherwise. This optional mounting is used to place a camera, such as shown in FIG. 2, facing rearward to keep track of children or pets in the back seat, to view out the back window as an adjunct to the rear view mirror, as an alternative to a dashboard-mounted camera which can obstruct driver's view, etc. This optional mount is either permanently fixed, adjusted manually, or is remotely controlled as in FIG. 2.

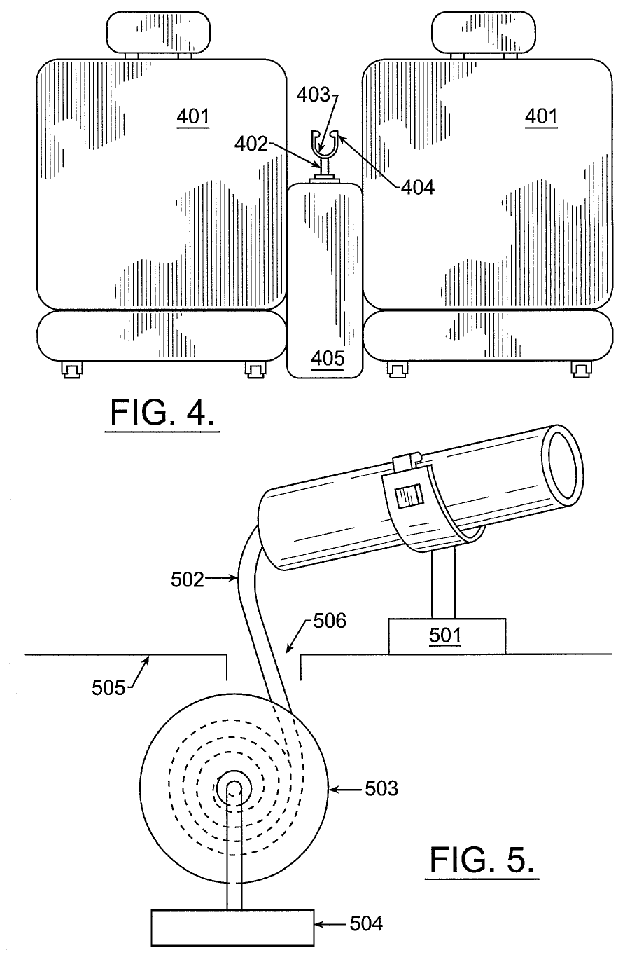

A mount as shown in FIG. 4 is, optionally, used in conjunction with the mount shown in FIG. 2 and a single camera by supplying the camera with an infrared or radio channel, or by a long cable, used for control and video signals, as shown in FIG. 5. The camera is placed in either mount by gently pushing it into the ‘C’ clip, which flexes around and grabs the camera barrel. Further, the camera on its physical, IR or radio tether, is used to look into dark and/or inaccessible areas, for example, to look under the driver's seat for a set of dropped keys; or, to display an enhanced (brighter, larger, freeze framed, etc.) image from a paper map or written directions. For such applications, a magnifying lens on the camera and/or red illumination (which does not unduly degrade the vehicle operator's night vision) are, optionally, employed. The entire camera system of FIG. 2 is shown (501) without additional element numbers. The cable (502) which, in FIG. 2, is optionally run through shaft (207), passes through an opening (506) in the dashboard (505) and is kept from tangling by a retractable reel (503) mounted (504) within the dashboard cavity.

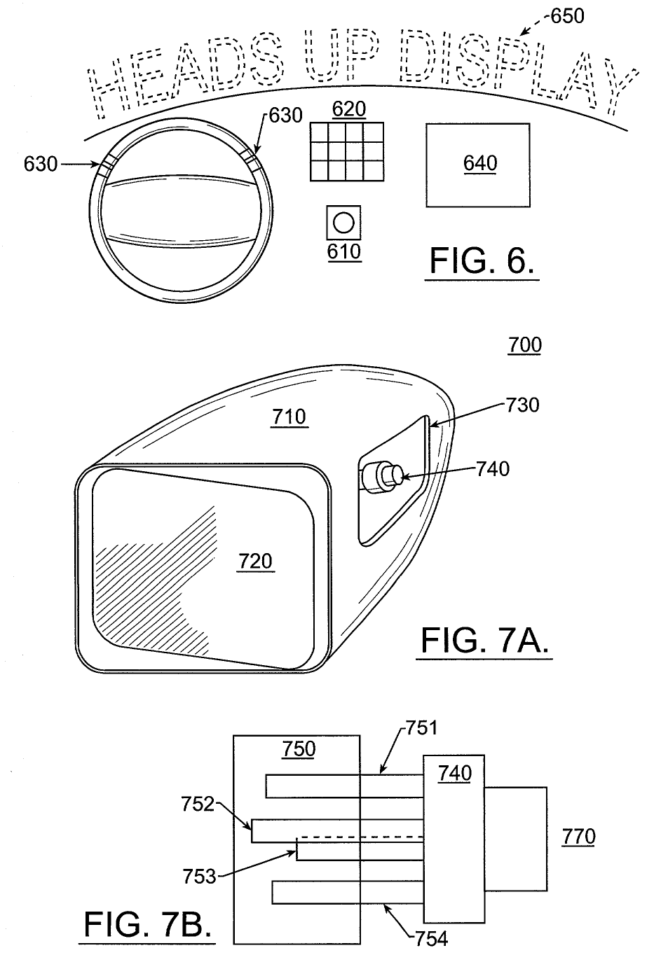

FIG. 6 shows alternative user input devices and displays. The joystick of FIG. 3 is shown as (610). Buttons or switches (toggle, momentary on, up/down, or otherwise) are shown as (620). These are used alone, or in combination with one or more two-axis or four-axis control devices (610). The three rows of four shown are assigned, for example, as: select front, rear, left and right camera (top row, mutually exclusive push bottoms); move camera up, down, left and right (middle row, momentary on); adjust lens zoom in, zoom out, focus near and focus far (bottom row, momentary on). Alternately, switches and buttons are mounted on the steering wheel (630) as is common with controls for ‘cruise control’, radio and other systems. One display alternative is a ‘heads-up’ display (650) as is used in the Cadillac system. However, since the items being displayed are not necessarily in the field of view of the windshield, having them overlaid in front of the driver's line-of-sight may be distracting. Thus, in other embodiments a CRT or, preferably, a flat LCD panel or similar display, is mounted in (640) or flips up from (not shown) the dashboard. On the other hand, having to look away from the road is also distracting; and, an advantage of the ‘heads-up’ display (“HUD”) embodiment is that it brings items from the side (or rear) into the forward view of the driver. For some drivers familiar with the system, the HUD will prove preferable; however, especially for some new or occasional users, the panel will be preferable. Either or both are, optionally, supplied; as are any other suitable display device now known or later developed.

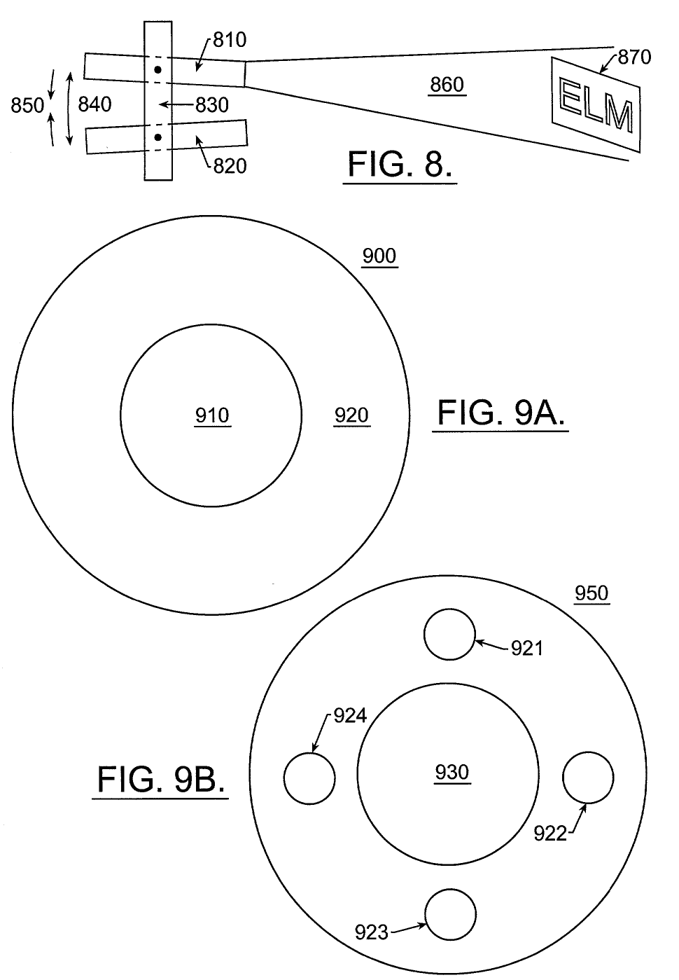

FIG. 7A depicts a camera mounted in a side mirror cowling (700); and, FIG. 7B an inner detail (770). In general, both left and right mirrors are utilized, although only the passenger's side is shown. A side view mirror (720) is mounted in a weather and wind cowling (710) as is standard practice, housing mirror control motors (not shown) as well. Into this otherwise standard unit has been cut an opening on the outer side (730) which is, optionally, covered by a transparent window. Alternately, or in addition, a camera can also be mounted pointing out a forward opening (not shown). Within the opening is mounted a small video camera, such as the low-cost, low-light, 1.1 inch square camera, Model PVSSQUARE¹⁰ available from PalmVID Video Cameras. An internal detail shows such a camera (740) connected to a mounting (750), for example, by four solenoids at the top (751), bottom (754), rear (752) and forward (753) which, when used in counter-coordinated manner will tilt the camera up/down, forward/rear (left/right). A central ball and socket pivot (not shown, for clarity) between the solenoids will prevent it from shifting rather than tilting. For example, with the top solenoid pushing out, and the bottom solenoid pulling in, the camera will tilt down. Alternately, a mirror placed between the lens and environment may be tilted, in much the same manner as the side view mirror, to change the area viewed by a static camera. Functionally similar mechanisms and configurations, other that these examples, are within the ken of those skilled in the mechanical, optical and automotive engineering arts and are within the intended scope of the instant invention.

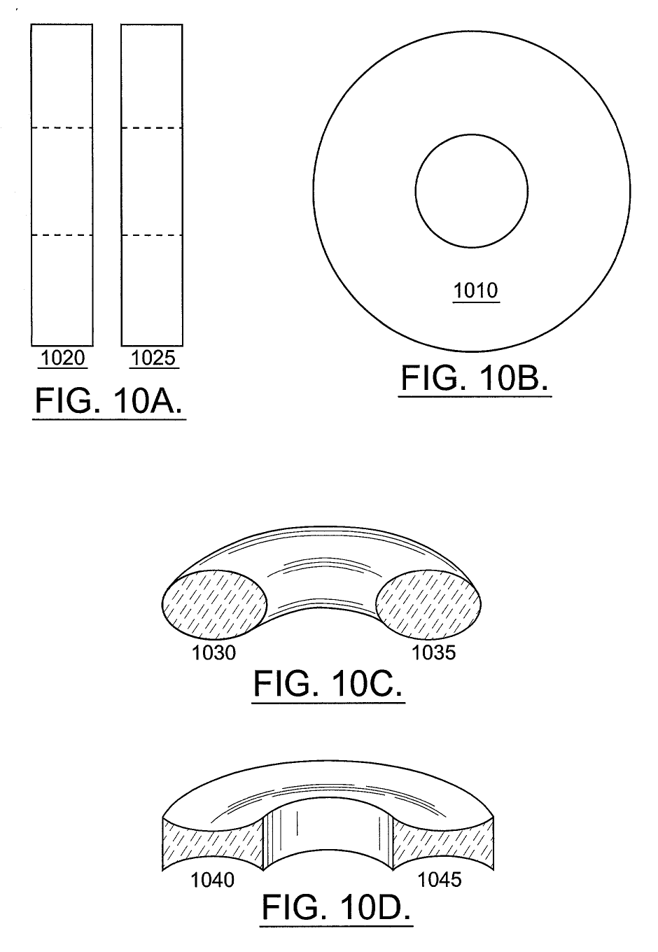

FIG. 8 shows an embodiment with an illumination source (810) and camera (820) mounted in a coordinated manner. The front ends of the camera (820) and illumination source (810) are tilted toward each other (840) in concert with focussing the camera nearer and, conversely, are tilted away from each other (850) as the camera is focussed on an object (870) further away. In this way the area illuminated (860) and the area viewed by the camera (870) overlap. Similarly, and optionally, a lens system on the illumination source makes it more of a narrow ‘spot’ as the camera view is zoomed in (telephoto) and, conversely, more of a dispersed ‘flood’ as the camera view is zoomed out (wide angle).

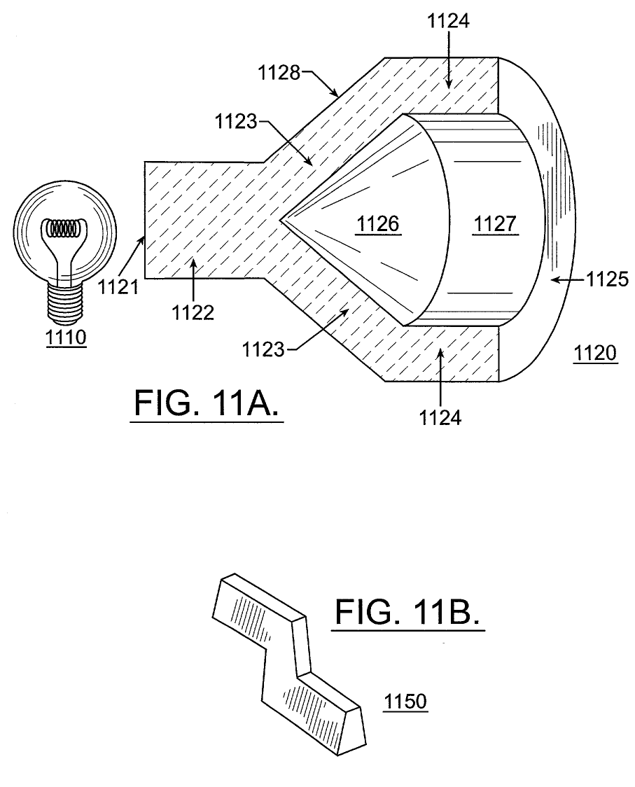

FIGS. 9A and 9B show alternative mechanisms for tracking auxiliary illumination with the camera. In FIG. 9A, in one front view (900) the central optical element for the camera (910) and surrounding annular illumination aperture (920) are coaxial. Thus, as a single barrel, or other mechanical unit, is oriented by controls, the camera view and illuminated area coincide. Alternately, in FIG. 9B, in another front view (950) the single camera (930) is surrounded by multiple (four shown here, but many more are, optionally, used) illumination sources (921-924). Each optionally has its own lens and/or filter; and, different illuminations sources optionally supply illumination in different spectra (e.g., IR, UV, visible white, visible color of a relatively narrow band, etc.).

Whether by alternative illumination sources, filters over common light sources, imaging components sensitive to different parts of the spectrum, etc., a multiplicity of spectra are, optionally, used for imaging at the same time, at different times, or under different circumstances. For example:

Particularly at night, far infrared (or other ‘invisible to human’ illumination), near infrared, or even red light (as is used to read maps when flying at night or in ships and submarines darkened in combat conditions, for example) is useable at night with minimal temporary blinding (i.e., with red, minimally exhausting the visual purple pigment) of other drivers whose visual field may be subjected to the illumination source of the system. Sonic imaging (sonar) is also useable in this regard; or, may be used simply to range distances for use in focussing visual sensors, as is common on some autofocus camera systems.

Far infrared (e.g., heat vision) has advantages distinguishing objects, such as pedestrians, from the surroundings, as is shown by the Cadillac ‘Night Vision’ system; and, can be used, for example, to identify and distinguish cold metallic street signs from the environment (e.g., the sky or foliage). However, as is also shown by the Cadillac ‘Night Vision’ system, the content of the sign may not be easily determined in this spectrum.

Ultraviolet, and the higher-frequency, ‘colder’ or blue end of the visible spectrum, are useful in that they cut through haze or fog better than the lower-frequency spectra.

Often street and traffic signs are printed in white on green, a recent alternative is white on dark red. If a white on green sign is illuminated by green light (or viewed through a green filter, or imaged by a component sensitive to green), both the white and green areas will appear very bright, will be relatively indistinguishable, and ‘reading’ of the text by computer will be hard. However, with illumination in the red range, the legibility of such a sign will be greatly increased. The opposite is true for the red and white sign. Consequently, if it is known that street signs in the area of travel are green on white, one technique is to search in the green spectrum for bright quadrilaterals in order to locate potential signs; then, to (optionally, zoom in to, and) image those areas in the red spectrum in order to read the text. If the local color scheme is not known, or in order to increase the amount of data available for recognition programs (as is discussed below) imaging is, optionally, performed in multiple spectra (e.g., red, green, blue, white) and the several images are analyzed separately or in composite.

Additionally, although for consumer applications for passenger vehicles the above examples are typical, imaging components or sensors sensitive to other electromagnetic spectra (e.g., x-ray, magnetic, radio frequency, etc.) can optionally be employed for the purposes described herein or for other purposes; for example, weapon detection by law enforcement or the military, interrogation of ‘smart’ street signs, etc.

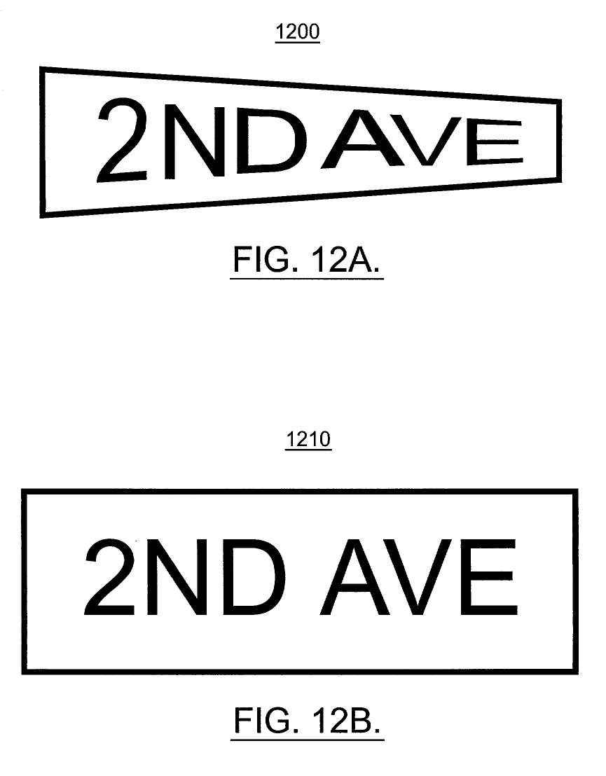

FIG. 10B shows, from the front, a lens system (1010) that is placed in front of the annular illumination area (920). Two, as shown from the side in FIG. 10A (1020) and (1025), or more lenses are, optionally, arranged in a compound lens arrangement in order to improve the ability to focus or disperse the light beam as needed. If each lens element (1010) is shown in cross-section it is, optionally, convex as in FIG. 10C (1030 & 1035), concave as shown in FIG. 10D (1040 & 1045), or as needed to implement the compound lens light source focussing system.

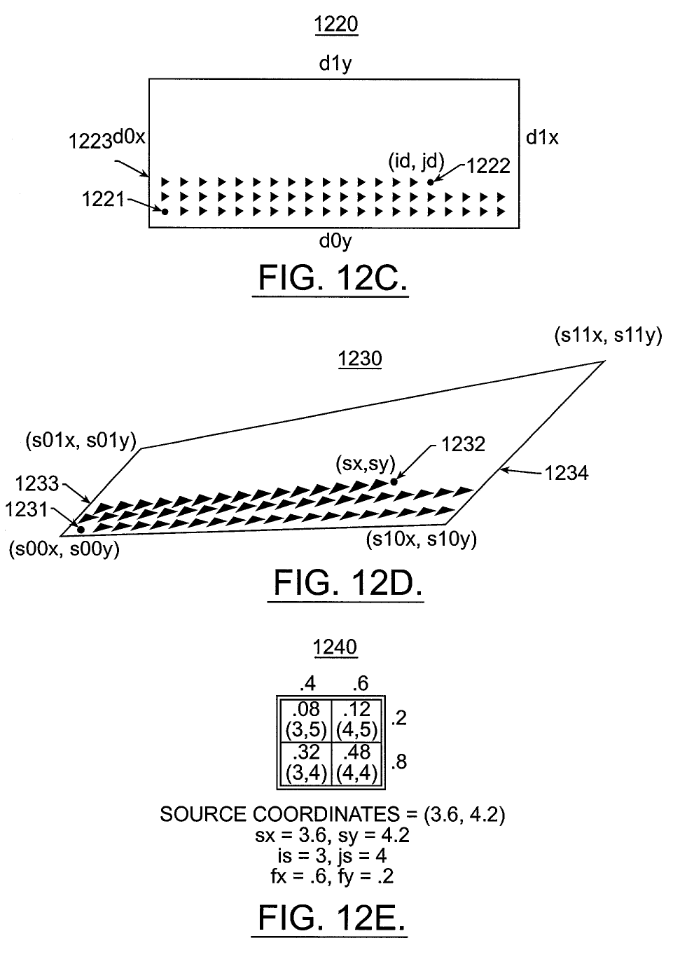

FIG. 11A shows an arrangement whereby the output from a light source (1110), positioned behind the camera subsystem (not shown, but placed within the hollow created by rear conical wall (1126) and curved side wall (1127)) is channeled around the camera. The light output is, thus, optionally passed through the lens subsystem of FIG. 10 and, finally, is output at the annular aperture (920). The key element of this arrangement is the lightguide (1120) which is shown in cross-section. Fabricated of glass, acrylic or other suitable optical waveguide material, the lightguide element is, optionally, treated on side faces (i.e., (1126), (1127) and (1128)) and not (1121) and (1125)) with a reflective coating to prevent light from leaking, and to increase the amount of light leaving the forward face (1125). Light enters the lightguide (1120) at the rear face (1121), generally circular in shape transverse to the average direction of travel of light. After traveling through a neck section (1122) the light path separates: in cross-section this appears to be a bifurcation into two paths (1123); but, in the solid object this causes the circular shape, transverse to the direction of travel, to become a ring with both the outer and inner radii increasing. Once the maximum radius is achieved, creating a circular cavity, the light path straightens (1124) in cross-section, creating an annulus of constant radii. Finally the light exits face (1125) as an annulus surrounding the camera subsystem placed within the hollow bounded aft by (1126) and surrounded by (1127). Viewed from the front this is comparable to view (900).

If the lightguide (1120) cannot be fabricated efficiently or cost-effectively; or, if it does not operate efficiently due to the dimensions, transverse to average direction of the light travel (e.g. transverse to travel from (1121) to (1125)), being to large, or otherwise, the one-piece lightguide (1120) is replaced with multiple lightguides, generally with smaller transverse dimensions. In one alternative embodiment, the one-piece lightguide (1120) is replaced by a multiplicity of more usual fiber optic light guides. In another embodiment, the one-piece lightguide (1120) is replaced by sections that, in aggregate, comprise a configuration substantially the same as (1120). The components, one shown in FIG. 11B (1150), are each thin wedge-shaped segment of (1120) bounded by two radii separated by several degrees. Many of these pieces, perhaps 20 to 120, are assembled, like pie wedges, to create the entire 360° shape, of which (1120) comprises 180°.

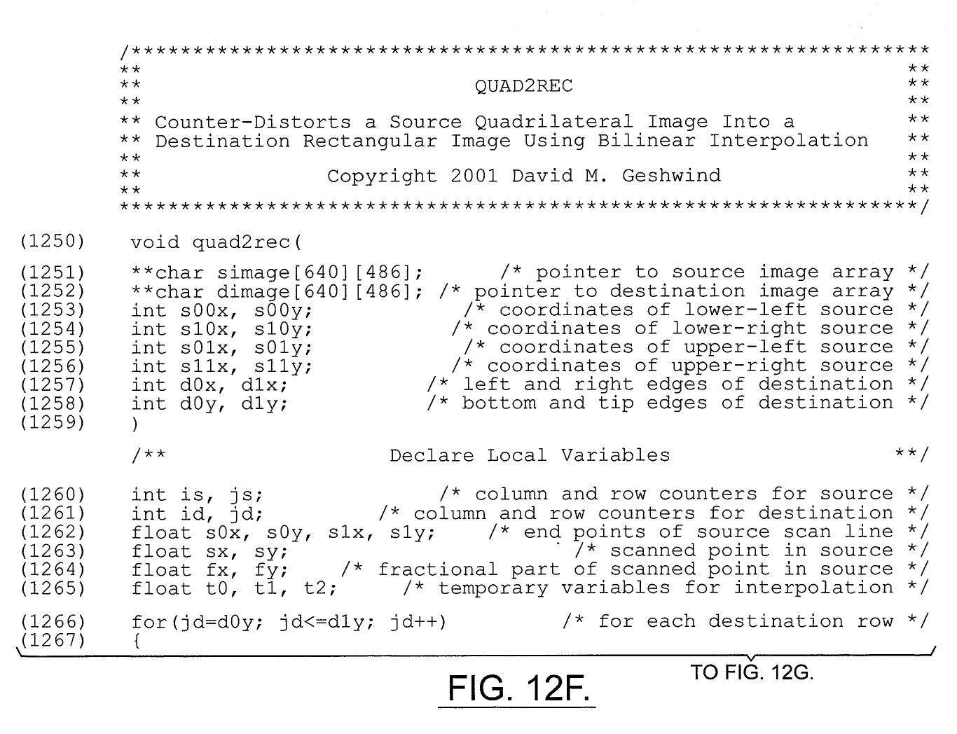

FIG. 12B depicts the counter-distortion (1210) of a distorted rectangular area (1200) in FIG. 12A as, for example, derived from the invention scanning a street sign from an angle. The rectangular area distorted by perspective (1200) is recognized, for example, as the intersection of four straight lines, or as a ‘patch’ of an expected color known to be used for street signs in a particular locale. It is counter-distorted, below, as best as possible by applying an inverse affine transform, to restore it to a more readable image.

The proper transform to apply is computed by any combination of several methods.

In one, the angle of tilt and pan placed on the camera orientation is used to compute the affine distortion that would be imposed on a rectangular area that is in front of, behind, or to the side of the automobile, depending upon which camera is being utilized. The reverse transform is applied to the image. This approach is more likely effective for vertical tilt, as street and highway signs are almost always mounted vertically, and the vertical keystone distortion component is also likely to be moderate. On the other hand, street signs are often rotated around their mounting poles and/or the car is on an angle or curved path and, thus, the horizontal keystoning component will, on occasion, be more severe and not just related to camera orientation. Additional transforms are optionally concatenated with those related to camera orientation, just described, to take these additional sign orientation elements into account.

Nevertheless, the affine transform, or its reverse, can account for and correct for any combination of rotations, translations and scalings in all three dimensions. If properly computed (based on camera orientation, lens specifications, and the assumed shape of known objects, such as rectangular street signs) by pattern recognition, image processing and liner algebra algorithms known to those skilled in the art, the transform responsible for the distortion can be determined and corrected for.

As an alternative (or in addition, either separately or at the same time, if needed) an additional technique is applied. This approach does not concern itself with how the distortion occurred but, rather, assumes that a visual quadrilateral is derived from a distorted physical rectangle, and stretches it back into a rectangular shape. Since affine transforms preserve straight lines and, thus, quadrilaterals remain quadrilaterals, this approach is, generally, valid.

The construction and operational details of image processing and feature (text, line, quadrilateral, rectangle, color patch, etc.) recognition software are well known in their respective arts. Although their combination and the use to which they have been placed herein, are not. It is, thus, expected that many practitioners will be acquiring packages of commercial software routines for the purpose of feature recognition and tracking¹¹. However, such recognition packages may not include image processing algorithms as well. The following discussion, regarding FIGS. 12C through 12E, is supplied for practitioners not particularly skilled in the art of image processing, who intend to program their own counter-distortion algorithm. What is provided, below, is an example that, while simple, is not necessarily complete in countering distortions caused by perspective, lens systems, etc. Nevertheless, it will provide some normalization so that displayed images will be easier for the operator of the vehicle to read.

FIGS. 12C through 12E depict diagrams illustrating this counter-distortion algorithm. FIGS. 12F and 12G comprises an example of program code to perform this image processing calculation. Such algorithms are well known to those skilled in the arts of image processing. The geometry of FIGS. 12C and 12D, and the algebra inherent in the algorithms of FIGS. 12E and 12F & 12G (1250-1287) will be discussed together, following.

A source quadrilateral (1230, 1251) has been recognized, as by the intersection of four lines, and is specified by the coordinates at the four corners where pairs of the closest to perpendicular lines intersect: (s00x, s00y), (s01x, s01y), (s10x, s10y) and (s11x, s11y); (1253-1256). A destination rectangle (1220, 1252) is set up in which will be reconstructed a counter-distorted rectangle, which is specified by the four sides d0x, d0y, d1x and d1y (1257-1258).

A raster pattern, from bottom to top (1266-1285), from left to right (1272-1284), is set up in the destination rectangle starting in the lower-left corner (1221) and proceeding (as shown by ≃) to some arbitrary point along the way (1222) with coordinates (id, jd). For each line jd) scanned in the destination rectangle (1220), the proportional altitude (1223) is applied to the left and right lines of the quadrilateral (1230) to determine the end points (1233 & 1234), s0x, s0y, s1x, s1y (1262), of a comparable skewed scan line in the quadrilateral (1268-1271). Then, for each point (id) along the destination line (e.g., 1222) the proportional distance along the destination line is applied to the skewed scan line to arrive at its coordinates (sx, sy) (1274-1275) (e.g., 1232).

Each of these floating point coordinates, sx and sy, is then separated into its integral part, is and js (1276-1277), and its fractional part, fx and fy (1278-1279).

The integral coordinates (is, js) specify the lower-left corner of a 2-by-2 cell of source pixels, shown in (1240) with sx=3.6, sy=4.2, is=3, js=4, fx=0.6 and fy=0.2. The number fx is used to assign fractions summing 1.0 to the two columns, and the number fy is used to assign fractions summing to 1.0 to the two rows. The value of each of the four pixels is multiplied by the fraction in its row and the fraction in its column. The four resultant values are summed and placed in the destination pixel (1222) at (i, j). The computer algorithm performs this bilinear interpolation somewhat differently as three calculations (1280-1282) and rounds and stores the result by step (1283).

It is noted that, by properly choosing the size of the destination rectangle, the image of the area of interest can be computationally enlarged (in addition to optical zooming) at the same time it is counter-distorted. Further, the values of the source and/or destination pixels are, optionally, processed to enhance the image regarding sharpening, contrast, brightness, gamma correction, color balance, noise elimination, etc., as are well-known in the art of image processing. Such processing is applied to signal components separately, or to a composite signal.

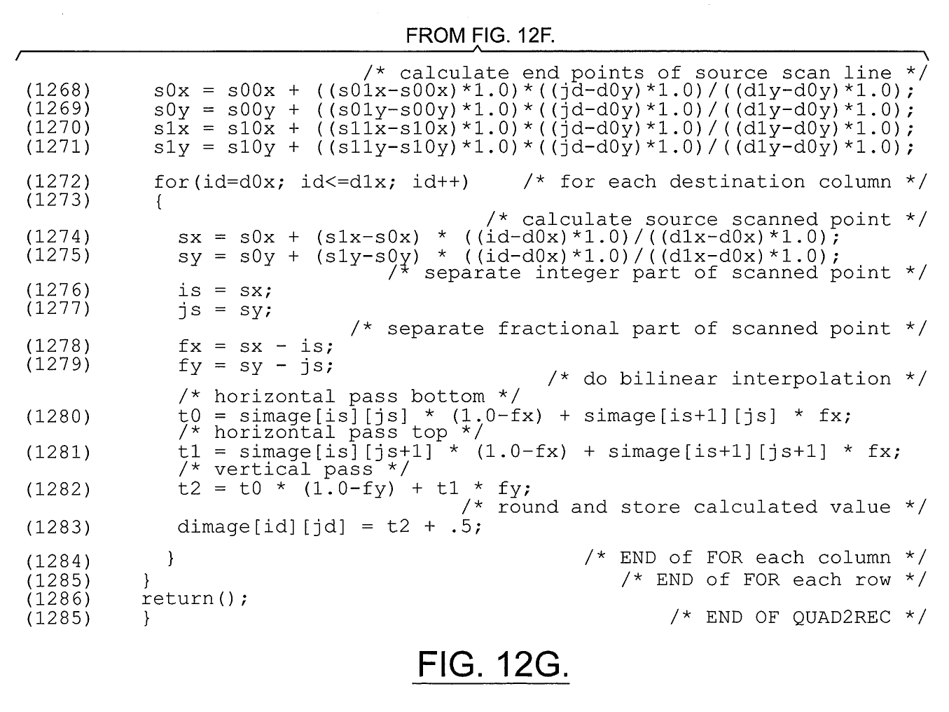

FIG. 13 depicts the partial recognition of text as, for example, from a street sign. The text is only partially recognized, due to being partially obscured, as by foliage, rust or otherwise. In order to assist the operator to correctly identify their location—specifically, to correctly identify the text on the street sign—the text that has been identified is compared with a list of street names (or other environmental features such as ‘points of interest’, hospitals, libraries, hotels, etc.) in a database, or downloaded, in order to identify potential (i.e., consistently partial) matches. The list is, optionally, culled to limit the search to streets and features that are within a specified radius from the vehicle location. Location is determined by a GPS, or other satellite or other automated navigation or location system; or, by consulting user input such as a zip code, designation of a local landmark, grid designation derived from a map, etc.

In the example of FIG. 13, the partially recognized text fragments comprise “IGH” and “VE” separated by an amount equal to about 6 or 8 additional characters (not necessarily depicted to scale in FIG. 13). Based on user input at an alphanumeric keyboard (e.g., 1532), which is part of the system, the list of potential matches is geographically limited. In this example the computer/user interaction comprises:

LOCATION: “Long Island Expressway Exit 43”

RADIUS: “2 Miles”

and the fragments are potentially matched with both: “EIGHTH ST. OVERPASS” and “HIGHLAND AVENUE”. Although additional artificial intelligence techniques (for example, assessing the spacing of the missing text between the two fragment) could be used to distinguish between these two possibilities, in this example the spacing is so close that further pruning would not likely be reliable.

The construction and operational details of text recognition, GPS or automated navigation systems, and automated map and street databases, are well known in their respective arts. Although, their combination and the use to which they have been placed herein, are not.

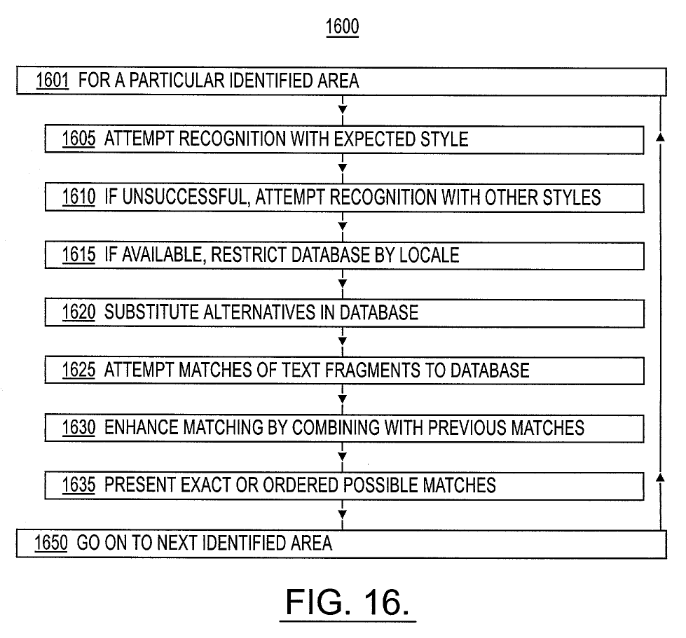

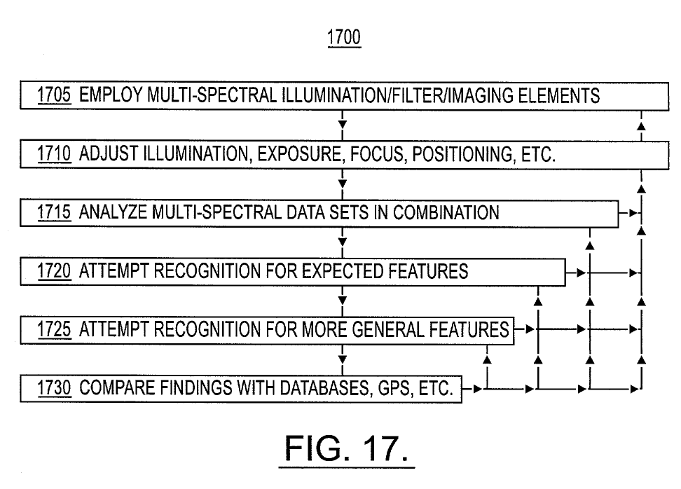

FIG. 16 depicts a program flow for partial text look-up. After areas likely to contain street signs or other desired information have been identified, whether by a human operator or by artificial intelligence software as described herein and, in particular, with respect to FIG. 17, each such area is subjected to text recognition software and the following partial text look-up procedure (1600).

For a particular area identified by human and/or software (1601) an attempt at text recognition is made with the style expected (1605). Elements of style comprise font, color, size, etc. Expectations are based on observation (e.g., other signs in the area are white text on red, rendered in a serif font, at 85% the height of the rectangular sign of 8 by 32 inches, and a neural network or other AI software routine is trained on local signage, as is common practice with AI and recognition software) or knowledge of the locale (e.g., a database entry indicates signs in downtown Middleville are black text on yellow, rendered in an italic san serif font, in letters of 3 inches high on signs as long as necessary to accommodate the text). If this step is unsuccessful, additional attempts at text recognition are carried out with other styles (1610).

Prior to searching for the recognized text fragments in the database of street names and other environmental features, if approximate location data is available, it is optionally used to restrict the database to names and features within a fixed or adjustable range of the expected location (1615). Further, alternative substitutions are made in the database (1620); for example, ten, tenth, X, 10 and 10^{TH}. Attempts are then made to match text fragments to the database (1625) as discussed with respect to FIG. 13.

The matching process is enhanced by combining knowledge of the current match with previous matches (1630). For example, if one street sign has been identified with high confidence as “Broadway”, the signs of intersecting streets are first, or more closely, attempted to be matched with the names of streets that intersect Broadway in the database. Or, if the last street was positively identified as “Fourth Ave”, the next street will be considered a match of higher confidence with “Fifth Ave” or “Third Ave” (the next streets over in each direction) even with very few letters (say, “- - - i - - - Ave”) than would a match of the same text fragment with “First Ave” or “Sixth Ave.”, even though each of these also has an “i” embedded within it. If a compass is integrated into the system, the expectations for “Fifth Ave” and “Third Ave” are further differentiable.

Similarly, even for the partially identified text provisionally identified, partial matches (of that found) are made. For example: “a” and “e” and “o” are often confused by text recognition software, as are “g” and “q”. Therefore, text matching all identified letters will take precedence, but partial matches are also considered. Such text matching algorithms are developed and well-known in the art. Once a match to partial (either partially obscured or partially not matching) is made, an additional attempt is optionally made to recognize a potential match. For example, if a sequence “Abolene” is provisionally identified, and the sequence “Abalene” is in the database, an additional attempt is made by a text recognition confirming algorithm to see if the “o” could be reasonable recognized as an “a” in light of this expectation.

If there is an exact match, or if only one match is identified as the only reasonable match, it is presented; or, if several possible matches are identified, they are presented in confidence order based on factors such as amount of text identified and/or matched, geographic location, proximity to previously identified elements, etc. (1635). The process is then repeated for the next identified area (1650).

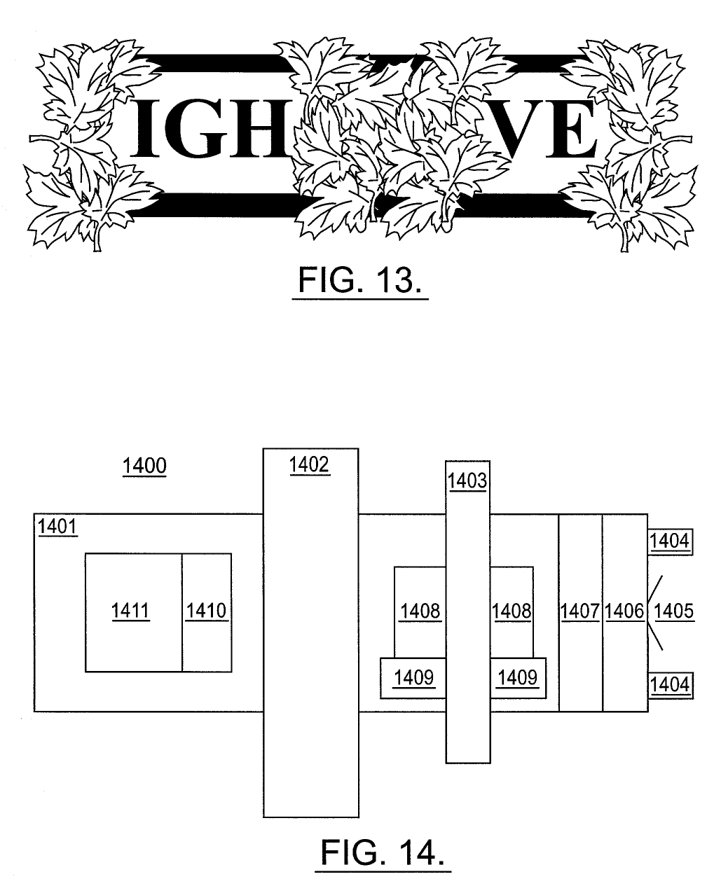

FIG. 14 depicts a system diagram of each camera subsystem (1400). A camera housing (1401) is held within a two axis electronic control mounting (1402) which, taken together, are similar to FIG. 2 with details omitted. Electronically controllable focus and zoom ring (1403) is mounted slightly behind the front of the camera subsystem, around the lens subsystem (1408).

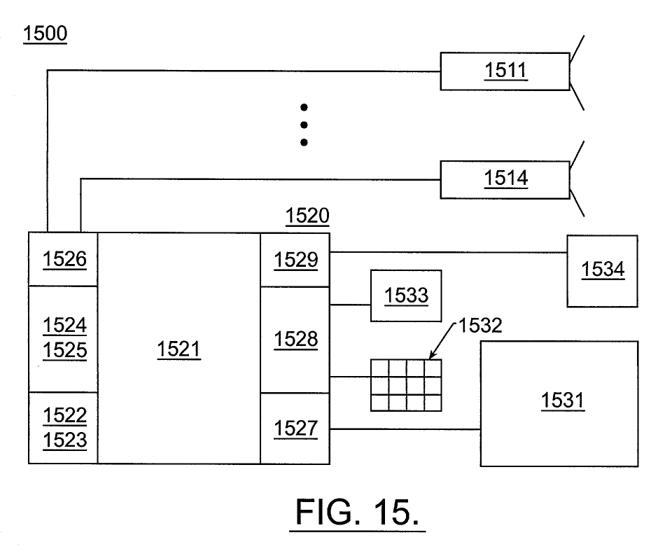

At the front is shown the cross-sections (above and below) of the protruding part of an annular illumination source (1404) such as is shown in FIGS. 9, 10 and 11. The aperture of the camera (1405) is forward of electronically selectable filters (1406), electronic iris (1407) and compound zoom lens system (1408). The lens (1408) sits in an, optional, optical/mechanical image stabilization subsystem (1409). Behind these is shown the electronic imaging element (1410) such as a CCD digital imaging element, and a digital memory and control unit (1411). These convert the optical image to electronic; process the image; and, control the other components automatically (e.g. autofocus, automatic exposure, digital image stabilization, etc.). Control and signal connections between components of (1400) and between it and other system components shown in FIG. 15, are not show here in the interests of clarity.

FIG. 15 depicts an overall system (1500) diagram. Multiple camera subsystems, such as (1400) shown in FIG. 14 are, here, present as (1511) . . . (1514). These each send visual information to, and exchange control signals with, a digital processor (1520) used for control and image processing. The digital processor further comprises: a central processing unit (1521); a mass storage unit, e.g., hard disk drive (1522); control, communications, artificial intelligence, image processing, pattern recognition, tracking, image stabilization, autofocus, automatic exposure, GPS and other software & database information stored on disk (1523); main memory, e.g., RAM (1524); software and data in use in memory (1525); control and imaging interface to/from cameras (1526); interface to display (1527); interface to user input devices, e.g., joysticks, buttons, switches, numeric or alphanumeric keyboard, etc. (1528); and, a satellite navigation communications/control (e.g., GPS) interface (1529). In addition, the system comprises input/output components including: CRT and/or LCD and/or heads-up display (1531); key/switch input unit, including optional alphanumeric keyboard (1532); joystick input unit (1533); and, a GPS or other satellite or automatic navigation system (1534).

FIG. 17 depicts program flow (1700) for feature recognition. The first thing to note is that, although these steps are presented in an ordered loop, during execution various steps may be skipped feeding forward to any arbitrary step; and, the return or feedback arrows indicate that any step may return to any previous step. Thus, as will be illustrated below, these steps are executed in arbitrary order and an arbitrary number of times as needed.

In particular as described with regard to FIG. 16, above, once feature recognition functions are performed, partial or potential matches are made to database entries and, optionally, one or more subsequent rounds of feature recognition are performed with expectations provided by these potential matches.

Each step, as presented in diagram (1700) will now be briefly explained. The first step (1705) employs multi-spectral illumination, filters and/or imaging elements. These are, optionally, as differing as visible, ultraviolet, infrared (near-visible or heat ranges), and sonic imaging or range finding (even x-ray and radiation of other spectra or energies are, optionally, employed); or, as related as red, green and blue in the visible spectrum. Different imaging techniques are sometimes used for differing purposes. For example, within the same system: a sonic (or ultrasonic) ‘chirp’ is used for range finding (alternately stereo imaging, with two cameras or one moving camera, or other methods of range finding are used) such as is used in some consumer cameras; infrared heat imaging is used to distinguish a metallic street sign from the confusing (by visible obscuration and motion) foliage; and, visible imaging used to read text from those portions of the previously detected sign not obscured by foliage (see FIG. 13). Alternately, multiple spectra are used to create a richer set of features for recognition software. For example, boundaries between regions of different pixel values are most often used to recognize lines, edges, text, and shapes such as rectangles. As is also discussed above, luminance (i.e., monochromatic or black and white) signals may not distinguish between features of different colors that have similar brightness values; and, imaging through a narrow color band, for example green, would not easily distinguish green from white, a problem if street signs are printed white on green, as many are. Thus, imaging in red will work for some environmental elements, green for others, and blue for still others. Therefore, it is the purpose of the instant invention that, imaging in multiple color spectra be utilized and the superset, intersection and/or other logical combinations of the edges and areas so obtained be utilized when analyzing for extraction of features such as lines, shapes, text or other image elements and environmental objects.

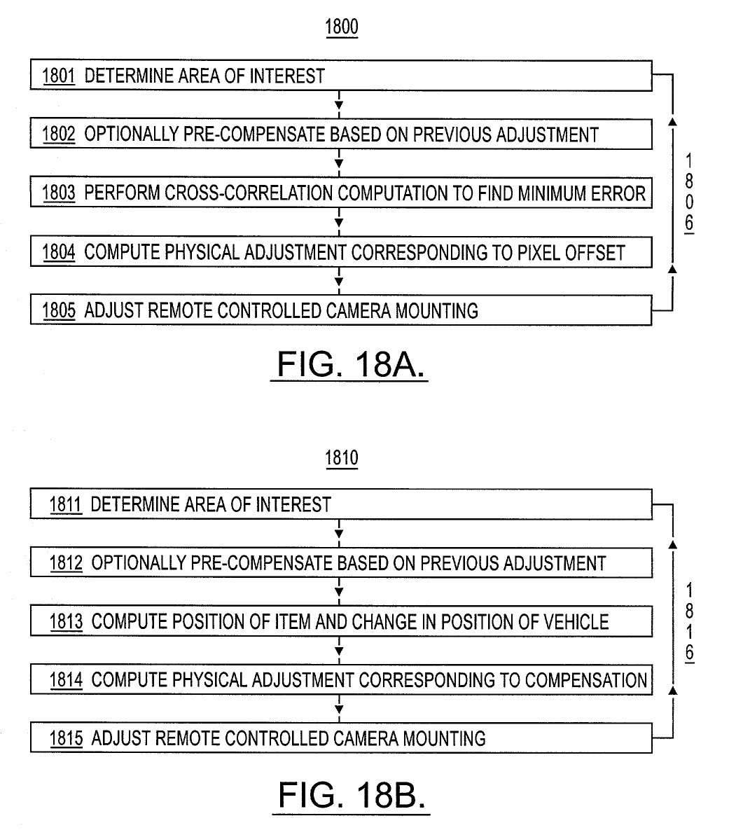

The next step of the program flow (1710) adjusts illumination, exposure, focus, zoom, camera position, or other imaging system element in order to obtain multiple images for processing, or to improve the results for any one image. Steps 1705 and 1710 feedback to each other repeatedly for some functions, for example, autoexposure, autofocus, mechanical/optical or digital image stabilization, object tracking (see FIG. 18) and other similar standard functions.

In the next step (1715) the multi-spectral data sets are analyzed separately or in some combination such as a logical conjunction or intersection of detected (usually transitions such as edges) data. For example, with a street sign printed in white on red, the basic rectangle of the sign will be well distinguished by edges visible in exposures made through both red and blue filters; the text against the background color of the sign will show as edges in the blue exposure (where red is dark and white bright) but not (at least not well) in the red (where both red and white will appear bright; and a ‘false’ edge (at least as far a text recognition is concerned) created by a shadow falling across the face of the sign may be eliminated from the blue exposure by subtracting the only well visualized edge in the red exposure.

In step (1720) an attempt is made to recognize expected features. For example, by local default settings, or geographic knowledge obtained by consulting a GPS subsystem, it is known that the street signs in the vicinity are: printed in white san serif text, on a green background, on rectangular signs that are 8 by 40 inches, that have a half inch white strip on the top and bottom, but not on the sides. This knowledge is used, for example, to select imaging through green and red filters (as discussed, above), and to ‘look’ for the known features by scanning for green rectangular (after counter-distortion) shapes, and using text recognition algorithms fine tuned for san serif fonts, on white shapes found on those green rectangles.

In step (1725) additional attempts are made to recognize more general features; for example, by: imaging while utilizing other colored filters or illumination; looking for signs (rectangles, of other colors) that are not those expected; looking for text other than on rectangles; using text recognition algorithms fine tuned for other than expected fonts; etc.

In step (1730) partial or interim findings are compared with knowledge of the names of street and other environmental features (e.g., hospitals, stores, highways, etc.) from databases, that are, optionally, keyed to location, which may be derived from features already recognized, a GPS subsystem, etc. These comparisons are utilized to refine the recognition process, such as is described in conjunction with FIG. 13.

In addition, other functions may be affected by arbitrarily executing and feeding back between the several steps of diagram (1700) as is described, above. For one illustrative, non-limiting example, consider a situation when several street signs are detected and they exist at several widely diverse distances from the camera. First, the camera is oscillated left and right and several exposures are compared. Using knowledge of the camera motion, optics, etc., the distinct parallax offsets between the several objects can be used to determine their distances from the camera. Then, rather than having to use a very small ‘pinhole’ aperture to create a large depth of field, the camera is separately focussed (and, optionally, with separate exposure levels) and image data captured separately for each such object. The relevant portions are removed from each such exposure and are analyzed separately, or a composite image is pieced together.

Similarly, in a situation where foliage is rustling in the foreground of a street sign, or an obscuring foreground object such as a light pole moves relative to the street sign as the vehicle travels, several frames are compared and different parts of the street sign obtained from different frames and pieced together to create a more complete image of the object than available from any single frame. Optionally the object separation process is enhanced by consulting depth information obtained by analyzing frames captured from multiple positions, or depth information obtained by sonic imaging; or, by motion detection of the rustling foliage or moving obscuring object, etc. The obscuring or moving object is eliminated from each frame, and what is left is composited with what remains from other frames.

In another example, after counter distortion processing, a roughly rectangular mostly red area over a roughly triangular mostly blue area, both with internal white shapes, is provisionally identified as a federal highway shield; a text recognition routine identifies the white shapes on blue as “I-95”. The camera then searches for the expected ‘white text on green rectangle’ of the affiliated exit signs and, upon finding one, although unable to recognize the text of the exit name (perhaps obscured by foliage or fog or a large passing truck), is able to read “Exit 32” and, from consulting the internal database for “Exit 32” under “I-95” displays a “probable exit identified from database” message of “Middleville Road, North”. Thus, the driver is able to obtain information that neither he nor the system can ‘see’ directly.

FIGS. 18A and 18B depict program flows for image tracking. Off-the-shelf software to control robotic camera mountings, and enable their tracking of environmental features, is available;¹² and, the programming of such features are within the ken of those skilled in the arts of image processing and robotic control. Nevertheless, for those practitioners of lesser skill, intent on programming their own functions, the program flow diagrams of FIG. 18A depicts one approach (1800), and FIG. 18B another approach (1810), which may be used separately, or in combination with each other or other techniques.

In FIG. 18A, the first approach (1800) comprises steps starting where the street sign or other area of interest is determined, by a human operator, the techniques of FIG. 17, or otherwise (1801). If needed, the position, relative to the vehicle, of the area or item of interest is computed, for example by a combination of information such as: the positions of the angular transducers effecting the attitudinal control of the robotic camera mounting; change in position of the vehicle, or vehicle motion (e.g., as determined by speed and wheel direction, or by use of inertial sensors); the distance of the item determined by the focus control on the camera lens; the distance of the item as determined by a sonic range finder; the distance of the item as determined by a dual (stereo) imaging, dual serial images taken as the vehicle or camera moves, or split-image range finder; etc. Further, electronic video camera autofocussing control sub-systems are available that focus on the central foreground item; ignoring items in the far background, nearer but peripheral items, or transient quickly moving objects. Once the area or item of interest is identified and separated, the cross-correlation and other image processing is, optionally, limited only to the pixels in that area of the digital image.

Since the tracking procedure will be typically performed many times each second, ideally before shuttering each frame, the parameters of one or several previous adjustments are, optionally, consulted and fitted to a linear, exponential, polynomial or other curve, and used to predict the next adjustment. This is then used to, optionally, predict and pre-compensate before computing the residual error (1802).

In this first approach, cross-correlation computation is then performed to find minimum error (1803). The previous image and current image are overlaid and (optionally limited to the areas of interest) subtracted from each other. The difference or error function is made absolute in value, often by squaring to eliminate negative values, and the composite of the error over the entire range of interest is summed. The process is repeated using various combinations of horizontal and vertical offset (within some reasonable range) and the pair with the minimum error results when the offsets (which can be in fractions of pixels by using interpolative techniques) best compensate for the positional difference between the two images. Rather than trying all possible offset combinations, the selected offsets between one or more previous pairs of images are used to predict the current offset, and smaller excursions around that prediction are used to refine the computation.

With knowledge of the optical properties of the lens system, the distance of the object of interest (obtained, for example, by the range finding techniques described above), and the pixel offset, a physical linear offset is computed; and, using straightforward trigonometric techniques, this is converted to the angular offsets to the rotational transducers on the robotic camera mount that are needed to affect the compensatory adjustments that will keep the item of interest roughly centered in the camera's field of view (1804). These adjustments are applied to the remote controlled camera mounting (1805); and, the process is repeated (1806) until the item of interest is no longer trackable, or a new item of interest is determined by the system or the user.

In FIG. 18B, the second approach (1810) comprises steps where each box has been labeled with an element number increased by 10 when compared to the previous flow diagram of FIG. 18A. For elements (1811, 1812, 1815 & 1816) the corresponding previous discussions are applicable, essentially as is. The primary difference between the two approaches is that the change in camera orientation is computed (1814) not from pixel offset in the two images, but by computation (1813) of the change in the relative position between the camera/vehicle and the item of interest.

As discussed above, the position, relative to the vehicle, of the area or item of interest is computed, for example, from the positions of the angular transducers effecting the attitudinal control of the robotic camera mounting, and distance of the item of interest determined by any of several methods. Additionally, the change in the relative position of the vehicle/camera and item of interest can be alternately, or in combination, determined by the monitoring the speed and wheel orientation of the vehicle, or by inertial sensors. Thus, the change in position in physical space is computed (1813); and, using straightforward trigonometric techniques, this is converted to the angular offsets to the rotational transducers on the robotic camera mount that are needed to affect the compensatory adjustments that will keep the item of interest roughly centered in the camera's field of view (1814).

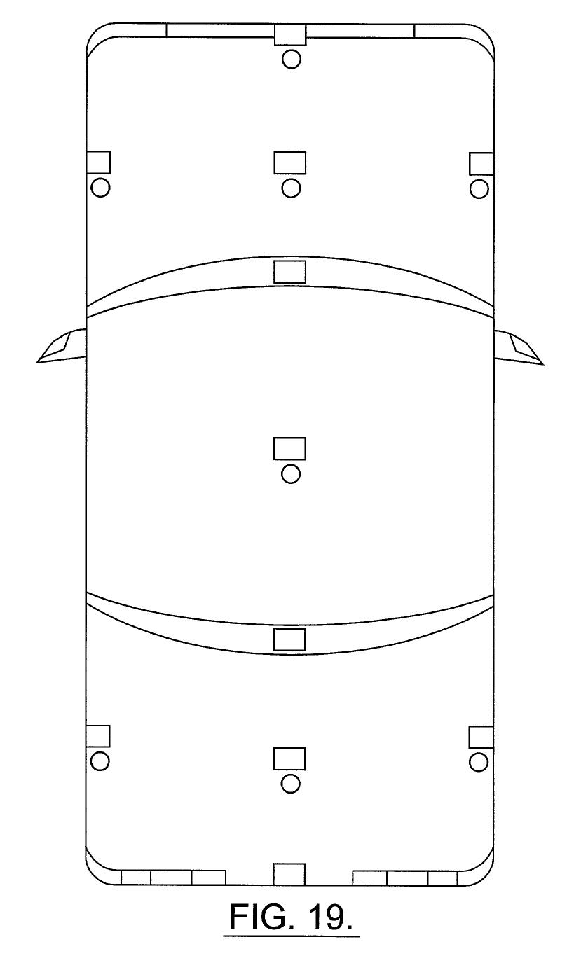

FIG. 19 depicts some alternative placements for cameras; other optional locations are not shown. Outward-facing cameras (shown as squares, see FIG. 2) may be placed centrally: behind the front grille, or rear trunk panel; on the hood, trunk or roof; integrated with the rearview mirror; or, on the dash (see FIG. 5) or rear deck, etc. Or, they may be placed in left and right pairs: behind front or rear fenders; in the side-view mirror housings (see FIG. 7); on the dash or rear deck, etc. In addition to improved viewing of street signs, such cameras are useful, for example, in visualizing low-lying items, especially behind the car while backing up, such as a carelessly dropped (or, even worse, occupied) tricycle.

Inward-facing cameras (shown as circles) are, optionally, placed in the cabin: on the dash (see FIG. 5) or rear deck; bucket bolster (see FIG. 4); or, with an optional fish-eye lens, on the cabin ceiling, etc. These are particularly useful when young children are passengers; and, it can be distinguished, for example, whether a baby's cries are from a dropped pacifier (which can be ignored until convenient), or from choking by a shifted restraint strap (which cannot).

Other optional cameras are placed to view compartments that are normally inaccessible during driving. For example, a camera (with optional illumination) in the trunk will let the driver know: if that noise during the last sharp turn was the groceries tumbling from their bag, and if anything broken (e.g., a container of liquid) requires attention; or, if their briefcase is, indeed, in the trunk, or has been left home. One or more cameras (with optional illumination) in the engine compartment will help determine engine problems while still driving, for example, by visualizing a broken belt, leaking fluid or steam, etc. As cameras become inexpensive and ubiquitous, it even becomes practicable to place cameras in wheel wells to visualize flat tires; or, nearby individual elements, for example, to monitor the level of windshield washer fluid.

The designs, systems, algorithms, program flows, layouts, organizations and functions described and depicted herein are exemplary. Some elements may be ordered or structured differently, combined in a single step, broken into several substeps, skipped entirely, or accomplished in a different manner. However, the elements and embodiments depicted and described herein do work. Substitution of equivalent technologies, or combination with other technologies, now in existence or later developed, are within the scope of the instant invention. Examples, without limitation, include: analog and digital technologies; functional operation implemented in special purpose hardware and general purpose hardware running control software; optical and electronic imaging; CRT, LCD and other display; sonic, electromagnetic, visible and extravisible spectra illumination and imaging sensitivity; etc.

The details of: engineering, implementation and construction of systems; creation and processing of information; and, implementation of the operation and human interface of functions; described herein are, generally, not, in and of themselves, the substance of the instant invention. Substitutions of, variations on, and combinations with, other processes, designs and elements, now in use or later developed, is considered to be within the scope of the invention.

It will thus be seen that the objects set forth above, among those made apparent from the preceding description, are efficiently attained and certain changes may be made in carrying out the above method and in the construction set forth. Accordingly, it is intended that all matter contained in the above description or shown in the accompanying figures shall be interpreted as illustrative and not in a limiting sense. Further, these figures, while illustrative, are not necessarily to scale, accurate perspective, or entirely consistent in their details.

Now that the invention has been described, what is claimed as new and desired to be secured by Letters Patent is:

1. An improved system for providing enhanced display of environmental navigation features comprising system components installed in a motor vehicle including:
a. a camera further comprising an optically configureable lens and an electronic imaging subsystem;
b. a positionable mounting holding said camera;
c. transducers effecting the configuration of said positionable mounting;
d. transducers effecting the optical configuration of said lens;
e. controls effecting said transducers;
f. an illumination source optionally used to enhance the performance of said electronic imaging subsystem;
g. a digital image processing subsystem used to optionally enhance the output of said electronic imaging subsystem; and,
h. a display showing the output of said electronic imaging subsystem.

2. A system as in claim 1, wherein said illumination source comprises visible light.

3. A system as in claim 1, wherein said illumination source comprises ultraviolet light.

4. A system as in claim 1, wherein said illumination source comprises infrared light.

5. A system as in claim 4, wherein said infrared light is in the near-visible spectrum.

6. A system as in claim 1, wherein said illumination source is configureable to coincide with the configuration of said lens.

7. A system as in claim 1, wherein said enhancement comprises image brightening.

8. A system as in claim 1, wherein said enhancement comprises image sharpening.

9. A system as in claim 1, wherein said enhancement comprises displaying, in an emphasized manner, at least one recognized object of interest in said image.

10. A system as in claim 1, wherein said enhancement comprises a compensatory counter distortion applied to at least a portion of said image based upon at least some edge or rectangle recognition and a computation of the distortion inherent in the image of at least one rectangular area which has been recognized in whole or in part in said image.

11. A system as in claim 1, wherein said enhancement comprises further processing based upon text recognition.

12. A system as in claim 11, wherein said recognized text is compared to a database of navigational labels to obtain potential matches.

13. A system as in claim 12, wherein said recognized text is only partially recognized.

14. A system as in claim 11, wherein said database of navigational labels is keyed to the output of a GPS or similar locating subsystem.

15. A system as in claim 1, further comprising automated tracking of at least one object of interest.

16. A system as in claim 1, further comprising image stabilization.

17. A system as in claim 1, further comprising:
a. text recognition;
b. automated tracking of at least one object of interest;
c. image stabilization; and,
d. counter distortion processing.

18. A system as in claim 1, wherein said environmental navigation feature is a road sign or house number.

19. A system as in claim 1, wherein:
a. said motor vehicle is a non-commercial civilian passenger automobile; and,
b. said camera comprises at least one video camera and is capable of capturing both daylight and night vision images.

20. A system as in claim 1, wherein:
a. said motor vehicle is a commercial civilian passenger automobile essentially equivalent to those known as taxicab or limousine; and,
b. said camera comprises at least one video camera and is capable of capturing both daylight and night vision images.

21. A system as in claim 1, wherein:
a. said motor vehicle is a commercial civilian passenger vehicle essentially equivalent to those known as omnibus or motor coach; and,
b. said camera comprises at least one video camera and is capable of capturing both daylight and night vision images.

22. A system as in claim 1, wherein:
a. said motor vehicle is a commercial civilian freight vehicle essentially equivalent to those known as trucks; and,
b. said camera comprises at least one video camera and is capable of capturing both daylight and night vision images.

23. An improved system for providing enhanced display of environmental navigation features comprising system components installed in a motor vehicle including:
a. a camera further comprising a lens and an electronic imaging subsystem;
b. a mounting holding said camera; and,
c. a display showing the output of said electronic imaging subsystem.

24. A system as in claim 23, wherein said lens is remotely optically configureable and further comprising transducers and controls to effect the configuration of said lens.

25. A system as in claim 24, wherein said controls receive input from a user electromechanical input device.

26. A system as in claim 25, wherein said input device is a multiple axis joystick.

27. A system as in claim 26, wherein said joystick employs both translational and rotational axes.

28. A system as in claim 24, wherein said controls receive input from a digital image analysis subsystem.

29. A system as in claim 23, wherein said mounting is remotely positionable and further comprising transducers and controls to effect configuration of said mounting.

30. A system as in claim 29, wherein said controls receive input from a user electromechanical input device.

31. A system as in claim 30, wherein said input device is a multiple axis joystick.

32. A system as in claim 31, wherein said joystick employs both translational and rotational axes.

33. A system as in claim 29, wherein said controls receive input from a digital image analysis subsystem.

34. A system as in claim 23, comprising, in addition, an illumination source used to enhance the performance of said electronic imaging subsystem.

35. A system as in claim 34, wherein said illumination source comprises visible light.

36. A system as in claim 34, wherein said illumination source comprises ultraviolet light.

37. A system as in claim 34, wherein said illumination source comprises infrared light.

38. A system as in claim 34, wherein said infrared light is in the near-visible spectrum.

39. A system as in claim 34, wherein said illumination source is configureable to coincide with the configuration of said lens.

40. A system as in claim 23, comprising, in addition, a digital image processing subsystem used to enhance the output of said electronic imaging subsystem.

41. A system as in claim 40, wherein said enhancement comprises image brightening.

42. A system as in claim 40, wherein said enhancement comprises image sharpening.

43. A system as in claim 40, wherein said enhancement comprises displaying, in an emphasized manner, the image of at least one recognized object of interest in said display.

44. A system as in claim 40, wherein said enhancement comprises a compensatory counter distortion applied to at least a portion of the image in said display based upon at least some edge or rectangle recognition and a computation of the distortion inherent in the image of at least one rectangular area which has been recognized in whole or in part in said image.

45. A system as in claim 40, wherein said enhancement comprises further processing based upon text recognition.

46. A system as in claim 45, wherein said recognized text is compared to a database of navigational labels to obtain potential matches.

47. A system as in claim 46, wherein said recognized text is only partially recognized and is compared to a database of navigational labels to obtain multiple potential matches.

48. A system as in claim 46, wherein said database of navigational labels is keyed to the output of a GPS or similar locating subsystem.

49. A system as in claim 23, further comprising automated tracking of at least one object of interest.

50. A system as in claim 23, further comprising image stabilization.

51. A system as in claim 23, further comprising:
a. text recognition;
b. automated tracking of at least one object of interest;
c. image stabilization; and,
d. counter distortion processing.

52. A system as in claim 23, wherein said environmental navigation feature is a road sign or house number.

53. A system as in claim 23, wherein said mounting and camera are mounted substantially within a side view mirror housing.

54. A system as in claim 29, wherein said mounting and camera are mounted substantially within a side view mirror housing.

55. A system as in claim 23, comprising, in addition, at least one supplementary imaging subsystem configured to provide supplementary images other than of environmental navigation features.

56. A system as in claim 55, wherein said supplementary images comprise images from within the engine compartment of said vehicle.

57. A system as in claim 55, wherein said supplementary images comprise images from within the trunk storage compartment of said vehicle.

58. A system as in claim 55, wherein said supplementary images comprise images from within the freight compartment of said vehicle.

59. A system as in claim 55, wherein said supplementary images comprise images from within at least one wheel well compartment of said vehicle.

60. A system as in claim 55, wherein said supplementary images comprise images from the area directly behind said vehicle which is normally not visible to said operator of said vehicle.

61. A system as in claim 55, wherein said supplementary images comprise images from the area directly in front of said vehicle which is normally not visible to said operator of said vehicle.

62. A system as in claim 55, wherein said supplementary images comprise images from the ‘blind spot’ of said vehicle which is normally not visible to said operator of said vehicle.

63. A system as in claim 55, wherein said supplementary images comprise images from the view out the rear window of said vehicle.

64. A system as in claim 55, wherein said supplementary images comprise images from the rear passenger compartment of said vehicle.

65. A system as in claim 64, wherein at least one supplementary imaging subsystem is configured to provide supplementary images of children seated in the rear passenger compartment.

66. A system as in claim 23, wherein at least one supplementary display subsystem is configured to provide system images to passengers seated in the rear passenger compartment.

67. A system as in claim 55, wherein said supplementary images comprise images from a printed map or other paper-based matter.

68. A system as in claim 55, wherein said supplementary images are gathered using illumination of a spectral range limited to reduce the negative impact on the night vision of said vehicle operator.

69. A system as in claim 55, wherein said supplementary images are displayed at a scale magnified when compared to the source.

70. A system as in claim 55, wherein said supplementary images comprise images of inaccessible and/or darkened areas of said vehicle.

71. A system as in claim 55, wherein said supplementary images are gathered using a hand-positionable camera transmitting its images via a wired or wireless tether.

72. A method for providing enhanced display of environmental navigation features comprising the steps of:
a. capturing an image by utilizing a camera further comprising a lens and electronic imaging subsystem;
b. displaying the output of said electronic imaging subsystem as an image.

73. A method as in claim 72, further comprising the step, between a. and b., of:
a1. inputting control information to transducers effecting the configuration of said lens.

74. A method as in claim 72, further comprising the step, between a. and b., of:
a2. illuminating the environment to enhance the performance of said electronic imaging subsystem.

75. A method as in claim 72, further comprising the step, between a. and b., of:
a3. enhancing, via a digital image processing subsystem, the output of said electronic imaging subsystem.

76. A system as in claim 72, wherein said enhancement comprises image brightening.

77. A system as in claim 72, wherein said enhancement comprises image sharpening.

78. A method as in claim 75, wherein said enhancement comprises displaying, in an emphasized manner, at least one recognized object of interest in said image.

79. A method as in claim 75, wherein said enhancement comprises a compensatory counter distortion applied to at least a portion of said image based upon at least some edge or rectangle recognition and a computation of the distortion inherent in the image of at least one rectangular area which has been recognized in whole or in part in said image.

80. A method as in claim 75, wherein said enhancement comprises text recognition.

81. A method as in claim 80, wherein said recognized text is compared to a database of navigational labels.

82. A method as in claim 81, wherein said database of navigational labels is keyed to the output of a GPS or similar locating subsystem.

83. A method as in claim 72, further comprising automated tracking of at least one object of interest.

84. A method as in claim 72, further comprising image stabilization.

85. A method as in claim 72, further comprising:
a. text recognition;
b. automated tracking of at least one object of interest;
c. image stabilization; and,
d. counter distortion processing.

86. A method as in claim 72, further comprising the steps, between a. and b., of:
a1. inputting control information to transducers effecting the configuration of said lens;
a2. illuminating the environment to enhance the performance of said electronic imaging subsystem;
a3. enhancing, via a digital image processing subsystem, the output of said electronic imaging subsystem by applying a compensatory distortion to at least a portion of said image based on the recognition of said edge or rectangle; and,
a4. enhancing, via a digital image processing subsystem, the output of said electronic imaging subsystem by displaying at least one proposed complete text selection based on partial text recognition, and the comparison of said partial text compared to a database of navigational labels keyed to the output of a GPS or similar locating subsystem.

87. A method as in claim 72, wherein said environmental navigation feature is a road sign or house number.

88. A method as in claim 86, wherein said environmental navigation feature is a road sign or house number.

90. A method for providing enhanced display of environmental navigation features comprising the steps of:
a. collecting an image comprising at least in part some environmental navigation feature;
b. enhancing said image via image processing; and,
c. displaying said enhanced image.

91. A method as in claim 90, further comprising automated tracking of at least one object of interest.

92. A method as in claim 90, further comprising image stabilization.

93. A method as in claim 90, further comprising:
a. text recognition;
b. automated tracking of at least one object of interest;
c. image stabilization; and,
d. counter distortion processing.

94. A method as in claim 90, further comprising range finding of an object of interest via sonar.

95. A method as in claim 90, further comprising range finding of an object of interest via binocular imaging.

96. A method as in claim 90, further comprising range finding of an object of interest via comparing sequential images captured from a moving vehicle.

97. A method as in claim 90, for image processing of expected objects comprising:
a. imaging a scene limited to a first spectral range in order to locate an object;
b. imaging said scene limited to at least one spectral range distinct from said first spectral range in order to locate features within said object.

98. A method as in claim 97, wherein said object is a road sign and said features are text.

99. A method as in claim 97, wherein the limitation to spectral ranges is achieved by the use of distinct filters.

98. A method as in claim 97, wherein the limitation to spectral ranges is achieved by the use of illumination sources providing radiant energy of distinct spectra.

99. A method as in claim 97, wherein said first spectral range is infra red heat imaging, and said second spectral range is visible light imaging.

100. A method as in claim 97, wherein said first spectral range is sonic energy used for object location, and said second spectral range is suitable for visual imaging.

101. A method as in claim 90, for image processing of objects comprising:
a. imaging a scene in at least three distinct spectral ranges; and,
b. comparing the resulting images in combination in order to locate objects and/or extract features within located objects.

102. A method as in claim 90, comprising the incorporation of knowledge of at least one quality of objects of interest expected within a specified neighborhood of the current geographic location when applying recognition software.

103. A method as in 102 wherein at least one of said at least one quality relates to shape.

104. A method as in 102 wherein at least one of said at least one quality relates to size.

105. A method as in 102 wherein at least one of said at least one quality relates to location.

106. A method as in 102 wherein at least one of said at least one quality relates to color.

107. A method as in 102 wherein at least one of said at least one quality relates to the proportion of areas of at least two distinct colors.

108. A method as in claim 90, wherein said enhancement comprises the accumulation over time of a multiplicity of partial images of an object of interest into a more complete image of said object of interest by:
a. retaining from at least some of said partial images portions that belong to said object of interest; and,
b. discarding and replacing at least some portions that do not belong to said object of interest with information from other of said partial images that does belong to said object of interest.

109. A method as in claim 108, wherein said partial images represent an object of interest being obscured by material that is actually moving over time with respect to said object of interest.

110. A method as in claim 108, wherein said partial images represent an object of interest being obscured by material that appears to be moving over time with respect to said object of interest due to the movement of a motor vehicle with respect to said object of interest and said material.

111. A method as in claim 110, wherein, for at least some of said partial images, a counter-distortion algorithm is applied to the portions retained such that said portions retained appear to be from substantially the same perspective.

112. A method as in claim 90, further comprising object tracking via image comparison.

113. A method as in claim 112, wherein said method further comprises steps including:
a. determining an area of interest in a current image;
b. performing a series of image cross-correlation computations, utilizing different offsets, between the area of interest of a previous image and the area of interest of said current image to find the substantially minimum error offset;
c. computation of a substantially optimal physical offset for said remotely positionable mounting to compensate for the offset found by the computations performed in step b.;
d. adjusting the position of said remotely positionable camera mounting according to the computation performed in step c.

114. A method as in claim 113, wherein said different offsets of step b. are limited to a neighborhood around an area obtained by extrapolating the results of at least one previous iteration of said calculation.

115. A method as in claim 90, further comprising object tracking via computation of the change in relative position between a motor vehicle and an object of interest.

116. A method as in claim 115, wherein said method further comprises steps including:
a. determining an object of interest at a current time;
b. performing a computation to determine the change in the relative position between said motor vehicle and an object of interest between a previous time and said current time;
c. computation of a substantially optimal physical mounting offset for said remotely positionable mounting corresponding to the computation performed in step b.;
d. adjusting the position of said remotely positionable camera mounting according to the computation performed in step c.

117. A method as in claim 116, wherein the computation of step b. is limited by extrapolating the results of at least one previous iteration of said calculation.

118. A method as in claim 90, further comprising partial text recognition.

119. A method as in claim 118, wherein said vehicle operator is provided with a definite match if available, or a list of potential matches ordered by confidence.

120. A method as in claim 118, wherein for at least one identified area:
a. at least one attempt is made to recognize text within said identified object utilizing constraints based on knowledge about at least one style set expected within a specified neighborhood of the current geographic location.

121. A method as in claim 120, wherein in addition:
b. if step a. is unsuccessful, at least one attempt to recognize said text within said identified object is made utilizing more general style constraints.

122. A method as in claim 118, wherein in addition:
a. a partially recognized text fragment is matched against a database of text comprising street signs and other environmental navigation features to produce possible matches.

123. A method as in claim 122, wherein said database is restricted to a specified neighborhood of the current geographic location.

124. A method as in claim 122, wherein said database is restricted based upon at least one previous successful match.

125. A method as in claim 122, wherein:
a. said matches take into account a measurement of the size of unrecognizable material between at least one pair of recognized text fragments and the size of the material between material matching each of the fragments of said pair in a database entry; and
b. the sizes are compared for a likelihood or confidence of matching based on the closeness of the two sizes.

126. A method as in claim 122, wherein there is feedback after at least one attempt at a match and a second match is attempted based on the additional information provided during feedback.

127. A method as in 126, wherein said feedback comprises the knowledge that a provisionally recognized letter corresponds to a geometrically similar letter in a database entry, and said second match attempts to alternatively recognize said provisionally recognized letter as said geometrically similar letter.

128. A method as in claim 90, wherein:
a. recognized text only partially matches one or more database entries; and,
b. said recognized text is re-processed for recognition utilizing knowledge about each of at least two potential partial matches in order to attempt a higher confidence for some of said potential matches with respect to others.

129. A method as in claim 90, wherein:
a. recognized text is only partially recognizable;
b. said recognized text is re-processed by determining a metric for at least one unrecognizable portion of said text; and,
c. comparing said metric to a metric determined for the equivalent portion of at least one partial potential match of a database entry.

130. A method as in claim 90, wherein:
a. recognized text only partially matches at least one database entry; and,
b. said recognized text is re-processed utilizing at least one more intensive or sophisticated recognition algorithm applied to at least one portion of said recognized text that does not match the equivalent portion of one or more potential matches, in order to determine if an alternative recognition target is reasonable.

131. A method as in claim 130, wherein said more intensive or sophisticated recognition algorithms employ artificial intelligence techniques.

132. A system for capturing images comprising:
a. a configureable image collection subsystem;
b. a configureable illumination subsystem; and,
c. a control subsystem capable of modifying the configuration of said image collection subsystem and said illumination subsystem in a coordinated manner.

133. A system as in claim 132, wherein:
a. said image collection subsystem is configured to point along a first axis;
b. said illumination subsystem is configured to point along a second axis;
c. said first axis and said second axis have, between them, a single rotational degree of freedom; and,
d. said coordinated manner comprises that said first axis and said second axis are configured in a coordinated manner to improve the overlap of the area of interest comprising the image being captured and the area being illuminated.

134. A system as in claim 133, wherein said single rotational degree of freedom is adjusted to conform to the approximate center of the area being illuminated to the approximate center of the area of the subject of the image being captured based upon the distance between said system and said areas.

135. A system as in claim 134, wherein said distance is determined in response to the configuration of the focus control of the lens of said image collection subsystem

136. A system as in claim 132, wherein:
a. said image collection subsystem further comprises a configureable lens subsystem;
b. said illumination subsystem further comprises a configureable lens subsystem; and,
c. said coordinated manner comprises that said first lens subsystem and said second lens subsystem are configured to improve the overlap of the area or interest comprising the image being captured and the area being illuminated.

137. A system as in claim 136, wherein said size of the area being illuminated is adjusted to conform to the size of the area of the subject of the image being captured.

138. A system as in claim 137, wherein said size is determined in response to the configuration of the zoom control of the lens of said image collection subsystem.

139. A system for capturing images comprising:
a. an image collection subsystem;
b. an illumination source subsystem with an illumination aperture comprising a configuration substantially occupying an area within some portion of an annulus surrounding the aperture of said image collection subsystem.

140. A system as in claim 139, wherein said area within some portion of an annulus comprises substantially an entire annular ring.

141. A system as in claim 140, further comprising a lens subsystem capable of adjusting the spread of said illumination.

142. A system as in claim 139, wherein said illumination source further comprises a multiplicity of illumination sources.

143. A system as in claim 142, wherein said multiplicity of illumination sources provide illumination in a multiplicity of distinct spectra of radiant energy.

144. A system for capturing images comprising:
a. an image collection subsystem;
b. an illumination source subsystem positioned such that said camera subsystem would, at least partially, obscure the path of the illumination provided by said illumination source from the subject of the image being collected;
c. a light guide positioned such that the path of said illumination progresses, at least in part, around at least some obscuring portion of said image collection subsystem, and emerges from a distal end of said light guide at a position peripheral to the obscuring portion of said image collection subsystem.

145. A system as in claim 144, wherein said distal end comprises a configuration substantially occupying an area within some portion of an annulus surrounding the aperture of said image collection subsystem.

146. A system as in claim 145, wherein said area within some portion of an annulus comprises substantially an entire annular ring.

147. A system as in claim 144, wherein the shape of said light guide provides a path that, at least in part, surrounds said image collection subsystem creating a cavity within which said image collection subsystem resides.

148. A system as in claim 147, wherein said at least in part comprises substantially.

149. A system as in claim 148, wherein said distal end comprises a configuration occupying an area substantially within an annular ring surrounding the aperture of said image collection subsystem.

150. A system as in claim 144, wherein said light guide further comprises a multiplicity of sub-units.

151. A system as in claim 147, wherein said light guide further comprises a multiplicity of sub-units.

152. A system as in claim 149, wherein:
a. said light guide further comprises a multiplicity of sub-units; and,
b. at least some of said sub-units comprise wedge-shaped sections of a portion of said light guide which port ion comprises a configuration substantially comprising an arc of a circularly symmetrical volume.
